(19) United States
(12) Patent Application Publication
(10) Pub. No.: US 2026/0128003 A1
(43) Pub. Date: May 7, 2026

(54) DISPLAY PANEL AND DISPLAY DEVICE

(71) Applicant: Wuhan Tianma Microelectronics Co., Ltd. Shanghai Branch, Shanghai (CN)

(72) Inventor: Mengmeng ZHANG, Shanghai (CN)

(73) Assignee: Wuhan Tianma Microelectronics Co., Ltd. Shanghai Branch, Shanghai (CN)

(21) Appl. No.: 19/424,955

(22) Filed: Dec. 18, 2025

(30) Foreign Application Priority Data
Jun. 26, 2025 (CN) 202510876077.3

(51) Int. Cl. G09G 3/32

(52) U.S. Cl. CPC G09G 3/32; G09G 2310/0267; G09G 2310/0286; G09G 2320/0233

(57) ABSTRACT

A display panel includes a driver circuit which includes n stages of cascaded shift register units; the first output terminal or the second output terminal of an x^{th}-stage shift register unit is electrically connected to the forward input terminal of a y^{th}-stage shift register unit, and the reverse input terminal of the y^{th}-stage shift register unit is electrically connected to the first output terminal or the second output terminal of a k^{th}-stage shift register unit; in a forward scan mode, a first-stage shift register unit to an n^{th}-stage shift register unit sequentially output the effective pulse of a first gate signal and sequentially output the effective pulse of a second gate signal; in a reverse scan mode, the n^{th}-stage shift register unit to the first-stage shift register unit sequentially output the effective pulse of the first gate signal and sequentially output the effective pulse of the second gate signal.

### CROSS-REFERENCE TO RELATED APPLICATION

This application claims priority to Chinese Patent Application No. 202510876077.3, filed on Jun. 26, 2025, the disclosure of which is incorporated herein by reference in its entirety.

### TECHNICAL FIELD

The present disclosure relates to the field of display technology and, in particular, to a display panel and a display device.

### BACKGROUND

With the advancement of display technology, electronic products featuring display functions have been widely adopted across various domains. The electronic products with display capabilities, such as televisions, mobile phones, computers and personal digital assistants, have become indispensable components in people's daily lives and work. The display panel serves as the core structure enabling the display function within electronic products.

A display panel typically includes multiple pixel circuits arranged in an array and a driver circuit. The driver circuit can perform progressive scanning on the pixel circuits by supplying gate drive signals to each row of pixels to enable the pixel circuits in each row to display and emit light, thereby allowing the display panel to present corresponding images.

However, due to the limitation of the functions and structures of the driver circuits, when a pixel circuit includes multiple functional modules, different driver circuits need to be set to separately supply gate drive signals to different functional modules in the pixel circuit, and as a result, the driver circuits occupy a significant amount of space, which is unfavorable for achieving the narrow-bezel design of the display panel, thereby adversely affecting the display performance of the display panel.

### SUMMARY

The present disclosure provides a display panel and a display device to reduce the size of the driver circuit, thereby facilitating the implementation of the narrow-bezel design of the display panel and improving the display performance of the display panel.

In a first aspect, embodiments of the present disclosure provide a display panel. The display panel includes a driver circuit.

The driver circuit includes n stages of cascaded shift register units, where n is a positive integer greater than or equal to 2.

The shift register unit includes a scan control module, a drive control module, a first output module, a second output module, a forward input terminal, a reverse input terminal, a forward control terminal, a reverse control terminal, a first clock terminal, a second clock terminal, a third clock terminal, a first output terminal and a second output terminal. In the same shift register unit, the scan control module is electrically connected to the forward input terminal, the reverse input terminal, the forward control terminal, the reverse control terminal and an input node, the drive control module is at least electrically connected to the input node, the first clock terminal, a first node and a second node, the first output module is at least electrically connected to the first node, the second node, the second clock terminal and the first output terminal, and the second output module is at least electrically connected to the first node, the second node, the third clock terminal and the second output terminal.

The first output terminal or the second output terminal of an x^{th}-stage shift register unit is electrically connected to the forward input terminal of a y^{th}-stage shift register unit, and the reverse input terminal of the y^{th}-stage shift register unit is electrically connected to the first output terminal or the second output terminal of a k^{th}-stage shift register unit, where 1≤x<y<k≤n, and x, y and k are positive integers.

In the same shift register unit, the effective pulse of a first gate signal output from the first output terminal and the effective pulse of a second gate signal output from the second output terminal are sequentially shifted.

The operating mode of the display panel includes a forward scan mode and a reverse scan mode. In the forward scan mode, a first-stage shift register unit to an n^{th}-stage shift register unit sequentially output the effective pulse of the first gate signal and sequentially output the effective pulse of the second gate signal. In the reverse scan mode, the n^{th}-stage shift register unit to the first-stage shift register unit sequentially output the effective pulse of the first gate signal and sequentially output the effective pulse of the second gate signal.

In a second aspect, the present disclosure provides a display device. The display panel includes the display panel described in the first aspect.

### BRIEF DESCRIPTION OF DRAWINGS

FIG. 1 is a structure diagram of a display panel in the related art;

FIG. 2 is a structure diagram of another display panel in the related art;

FIG. 3 is a structure diagram of a display panel according to an embodiment of the present disclosure;

FIG. 4 is a structure diagram of a shift register unit according to an embodiment of the present disclosure;

FIG. 5 is a drive timing diagram of a display panel according to an embodiment of the present disclosure;

FIG. 6 is a driving timing diagram of another display panel according to an embodiment of the present disclosure;

FIG. 7 is a structure diagram of another display panel according to an embodiment of the present disclosure;

FIG. 8 is a structure diagram of a driver circuit according to an embodiment of the present disclosure;

FIG. 9 is a structure diagram of another driver circuit according to an embodiment of the present disclosure;

FIG. 10 is a structure diagram of another driver circuit according to an embodiment of the present disclosure;

FIG. 11 is a structure diagram of another driver circuit according to an embodiment of the present disclosure;

FIG. 12 is a structure diagram of a pixel circuit according to an embodiment of the present disclosure;

FIG. 13 is a structure diagram of another shift register unit according to an embodiment of the present disclosure;

FIG. 14 is a structure diagram of another shift register unit according to an embodiment of the present disclosure;

FIG. 15 is a structure diagram of another shift register unit according to an embodiment of the present disclosure;

FIG. 16 is a structure diagram of another shift register unit according to an embodiment of the present disclosure;

FIG. 17 is a drive timing diagram of a shift register unit in the forward scan mode according to an embodiment of the present disclosure;

FIG. 18 is a drive timing diagram of a shift register unit in the reverse scan mode according to an embodiment of the present disclosure;

FIG. 19 is a structure diagram of another shift register unit according to an embodiment of the present disclosure;

FIG. 20 is a structure diagram of another shift register unit according to an embodiment of the present disclosure;

FIG. 21 is a structure diagram of another shift register unit according to an embodiment of the present disclosure;

FIG. 22 is a structure diagram of another shift register unit according to an embodiment of the present disclosure;

FIG. 23 is a drive timing diagram of another shift register unit according to an embodiment of the present disclosure;

FIG. 24 is a drive timing diagram of another shift register unit according to an embodiment of the present disclosure;

FIG. 25 is a structure diagram of another driver circuit according to an embodiment of the present disclosure;

FIG. 26 is a drive timing diagram of a driver circuit in the forward scan mode according to an embodiment of the present disclosure;

FIG. 27 is a drive timing diagram of a driver circuit in the reverse scan mode according to an embodiment of the present disclosure;

FIG. 28 is a structure diagram of another driver circuit according to an embodiment of the present disclosure;

FIG. 29 is a drive timing diagram of another driver circuit in the forward scan mode according to an embodiment of the present disclosure;

FIG. 30 is a drive timing diagram of another driver circuit in the reverse scan mode according to an embodiment of the present disclosure;

FIG. 31 is a structure diagram of another driver circuit according to an embodiment of the present disclosure;

FIG. 32 is a drive timing diagram of another driver circuit in the forward scan mode according to an embodiment of the present disclosure;

FIG. 33 is a drive timing diagram of another driver circuit in the reverse scan mode according to an embodiment of the present disclosure;

FIG. 34 is a structure diagram of another driver circuit according to an embodiment of the present disclosure;

FIG. 35 is a drive timing diagram of another driver circuit in the forward scan mode according to an embodiment of the present disclosure;

FIG. 36 is a drive timing diagram of another driver circuit in the reverse scan mode according to an embodiment of the present disclosure; and

FIG. 37 is a structure diagram of a display device according to an embodiment of the present disclosure.

### DETAILED DESCRIPTION

The present disclosure is further described in detail below in conjunction with drawings and embodiments. It is to be understood that the embodiments described herein are intended to illustrate the present disclosure and not to limit the present disclosure. Additionally, it is to be noted that for ease of description, only part, not all, of the structures related to the present disclosure are illustrated in the drawings.

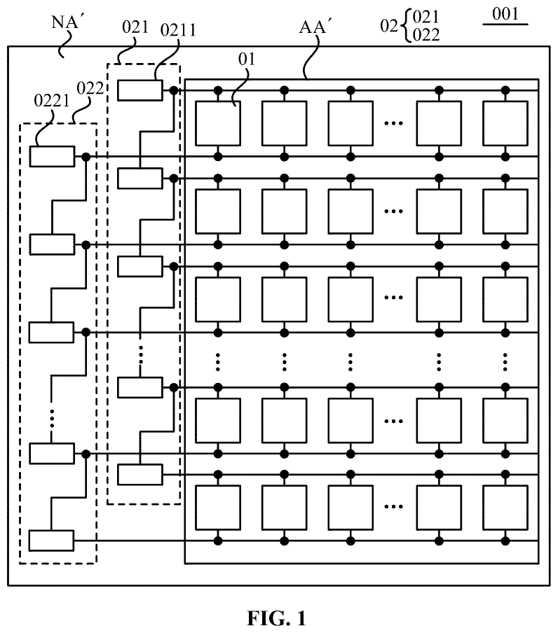

FIG. 1 is a structure diagram of a display panel in the related art. As shown in FIG. 1, the display panel 001 may include a display region AA′ and a non-display region NA′ surrounding the display region AA′. The display region AA′ is provided with multiple pixel circuits 01 arranged in an array, and the pixel circuit 01 may at least include a drive module, a light-emitting module, a first preset module and a second preset module. For example, the first preset module may include a reset module, the second preset module may include a data write module, the reset module can reset the drive module, the data write module can control a data signal to be written to the drive module, and the drive module is configured to selectively drive the light-emitting module to emit light according to the data signal, that is, the first preset module and the second preset module are separately turned on at different time periods to control the signal written to the pixel circuit 01.

Correspondingly, the non-display region NA′ is provided with a driver circuit 02, and the driver circuit 02 at least includes a first driver circuit 021 and a second driver circuit 022. The shift register unit 0211 in each stage in the first driver circuit 021 supplies a gate drive signal to the first preset modules of each row of the pixel circuits 01 to control the first preset modules to be turned on or off, and the shift register unit 0211 in each stage in the second driver circuit 022 supplies a gate drive signal to the second preset modules of each row of the pixel circuits 01 to control the second preset modules to be turned on or off. In this manner, the first driver circuit 021 and the second driver circuit 022 may drive various rows of pixel circuits 01 to display and emit light normally.

However, since the first preset modules and the second preset modules in the pixel circuits 01 need to be controlled by the first driver circuit 021 and the second driver circuit 022, respectively, at least two driver circuits (that is, the first driver circuit 021 and the second driver circuit 022) need to be provided in the non-display region NA′, a large space then needs to be reserved in the non-display region NA′ to arranged the driver circuits, and as a result, the size of the non-display region NA′ becomes large, thereby affecting the implementation of the narrow-bezel design of the display panel.

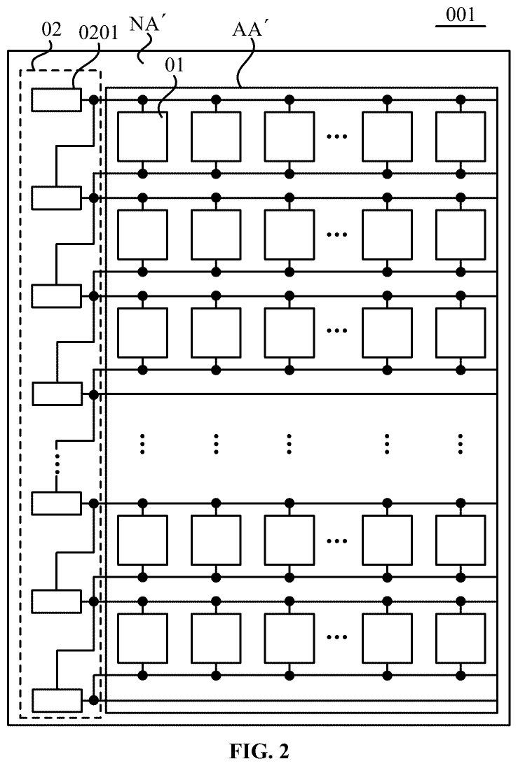

In the related art, as shown in FIG. 2, the first preset modules and the second preset modules of the pixel circuits 01 may also be electrically connected to the same driver circuit 02, and the same driver circuit 02 supplies gate drive signals to the first preset modules and the second preset modules of the pixel circuits 01 separately. For example, an (i+1)^{th}-stage shift register unit 0201 in the driver circuit 02 may supply a gate drive signal to the first preset modules of the (i+1)^{th} row of pixel circuits 02 and a gate drive signal to the second preset modules of the i^{th} row of pixel circuits 02 to be able to control the first preset modules of the (i+1)^{th} row of pixel circuits and the second preset modules of the i^{th} row of pixel circuits to be turned on or off. However, when the operating mode of the display panel includes the forward scan mode and the reverse scan mode, in the forward scan mode, the shift register units 0201 from the first stage to the last stage in the driver circuit 02 sequentially output the effective pulses of the gate drive signals to enable the first preset module and the second preset module in the same pixel circuit 02 to be turned on sequentially; additionally, for two adjacent rows of pixel circuits 02, the turn-on durations of the first preset modules in the preceding row of pixel circuits 02 are before the turn-on durations of the first preset modules in the subsequent row of pixel circuits 02, and the turn-on durations of the second preset modules in the preceding row of pixel circuits 02 are also before the turn-on durations of the second preset modules in the subsequent row of pixel circuits 02 to enable all rows of pixel circuits 02 to display and emit light normally; in reverse scan mode, the shift register units 0201 from the last stage to the first stage in the driver circuit 02 sequentially output the effective pulses of the gate drive signals, in this case, in the same pixel circuit, the turn-on duration of the first preset module is after the turn-on duration of the second preset module, and consequently, the reset and data write operations cannot be normally performed on the drive modules in the pixel circuits, thereby causing the pixel circuits to fail to normally display and emit light and affecting the display performance of the display panel.

To sum up, how to enable the display panel to meet the drive requirements in various operating modes on the premise of reducing the space occupied by the driver circuit, reducing the size of the driver circuit and reducing the size of the display panel has become an urgent technical problem to be solved at present.

To solve the above technical problems, embodiments of the present disclosure provide a display panel. The display panel includes a driver circuit. The driver circuit includes n stages of cascaded shift register units, where n is a positive integer greater than or equal to 2. The shift register unit includes a scan control module, a drive control module, a first output module, a second output module, a forward input terminal, a reverse input terminal, a forward control terminal, a reverse control terminal, a first clock terminal, a second clock terminal, a third clock terminal, a first output terminal and a second output terminal. In the same shift register unit, the scan control module is electrically connected to the forward input terminal, the reverse input terminal, the forward control terminal, the reverse control terminal and an input node, the drive control module is at least electrically connected to the input node, the first clock terminal, a first node and a second node, the first output module is at least electrically connected to the first node, the second node, the second clock terminal and the first output terminal, and the second output module is at least electrically connected to the first node, the second node, the third clock terminal and the second output terminal. The first output terminal or the second output terminal of an x^{th}-stage shift register unit is electrically connected to the forward input terminal of a y^{th}-stage shift register unit, and the reverse input terminal of the y^{th}-stage shift register unit is electrically connected to the first output terminal or the second output terminal of a k^{th}-stage shift register unit, where 1≤x<y<k≤n, and x, y and k are positive integers. The effective pulse of a first gate signal output from the first output terminal of the same shift register unit and the effective pulse of a second gate signal output from the second output terminal of the same shift register unit are sequentially shifted. The operating mode of the display panel includes a forward scan mode and a reverse scan mode. In the forward scan mode, a first-stage shift register unit to an n^{th}-stage shift register unit sequentially output the effective pulse of the first gate signal and sequentially output the effective pulse of the second gate signal. In the reverse scan mode, the n^{th}-stage shift register unit to the first-stage shift register unit sequentially output the effective pulse of the first gate signal and sequentially output the effective pulse of the second gate signal.

Through the above technical solutions, by providing the shift register unit in the driver circuit with a first output module, a second output module, a first output terminal and a second output terminal and by setting the first output module to control the first gate signal output from the first output terminal and the second output module to control the second gate signal output from the second output terminal, the effective pulses of the first gate signal and the second gate signal output by the same shift register unit may be sequentially shifted, that is, a shift register unit may output two gate drive signals sequentially shifted, thereby reducing the number of shift register units in the driver circuit, reducing the space occupied by the driver circuit, facilitating the implementation of the narrow-bezel design of the display panel and improving the display performance of the display panel. Furthermore, by electrically connecting the first output terminal or the second output terminal of the x^{th}-stage shift register unit to the forward input terminal of the y^{th}-stage shift register unit and electrically connecting the reverse input terminal of the y^{th}-stage shift register unit to the first output terminal or the second output terminal of the k^{th}-stage shift register unit, when the operating mode of the display panel is the forward scan mode, the first-stage shift register unit to the n^{th}-stage shift register unit may sequentially output the effective pulses of the first gate signals and sequentially output the effective pulses of the second gate signals under the control of the signals received by the forward input terminals, the clock signals of the clock terminals and the forward scan control signals of the forward control terminals of stages of shift register units, and when the operating mode of the display panel is the reverse scan mode, the n^{th}-stage shift register unit to the first-stage shift register unit may sequentially output the effective pulses of the first gate signals and sequentially output the effective pulses of the second gate signals under the control of the signals received by the reverse input terminals, the clock signals of the clock terminals and the reverse scan control signals of the reverse control terminals of the stages of shift register units. That is, the first gate signals and the second gate signals output by the stages of shift register units in the driver circuit may cooperate with the forward scan mode and the reverse scan mode of the display panel to enable the driver circuit to obtain both forward and reverse scan functions. Therefore, on the premise of ensuring that the driver circuit has a small size, the driver circuit has the forward and reverse scan functions to meet the scan requirements of the display panel in different modes, thereby broadening the application scenario of the display panel and improving the display performance of the display panel.

The above is the core idea of the present disclosure. Based on the embodiments of the present disclosure, all other embodiments obtained by those of ordinary skill in the art are within the scope of the present disclosure on the premise that no creative work is done. Technical solutions of the embodiments of the present disclosure are described clearly and completely below in conjunction with the drawings in the embodiments of the present disclosure.

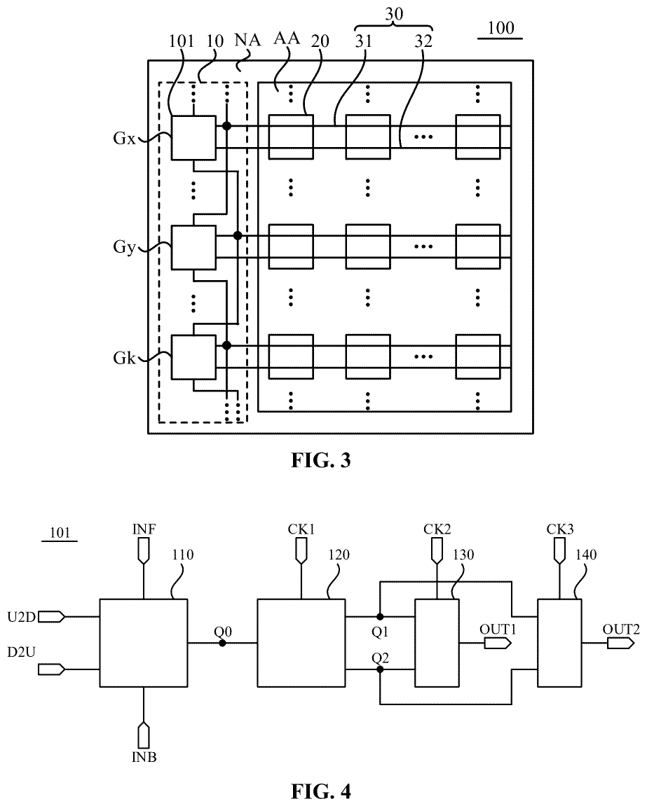

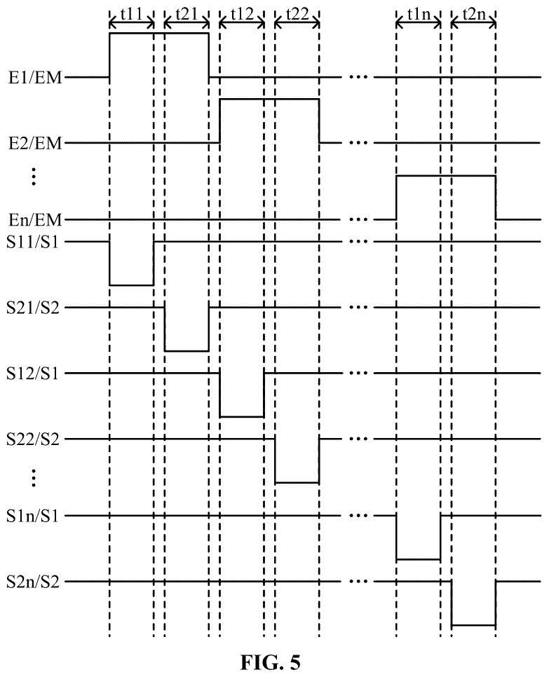

FIG. 3 is a structure diagram of a display panel according to an embodiment of the present disclosure, and FIG. 4 is a structure diagram of a shift register unit according to an embodiment of the present disclosure. With reference to FIGS. 3 and 4, the display panel 100 includes a driver circuit 10. The driver circuit 10 includes n stages of cascaded shift register units 101. The shift register unit 101 includes a scan control module 110, a drive control module 120, a first output module 130, a second output module 140, a forward input terminal INF, a reverse input terminal INB, a forward control terminal U2D, a reverse control terminal D2U, a first clock terminal CK1, a second clock terminal CK2, a third clock terminal CK3, a first output terminal OUT1 and a second output terminal OUT2. In the same shift register unit 101, the scan control module 110 is electrically connected to the forward input terminal INF, the reverse input terminal INB, the forward control terminal U2D, the reverse control terminal D2U and an input node Q0, the drive control module 120 is at least electrically connected to the input node Q0, the first clock terminal CK1, a first node Q1 and a second node Q2, the first output module 130 is at least electrically connected to the first node Q1, the second node Q2, the second clock terminal CK2 and the first output terminal OUT1, and the second output module 140 is at least electrically connected to the first node Q1, the second node Q2, the third clock terminal CK3 and the second output terminal OUT2. In the same shift register unit 101, the effective pulse of a first gate signal S1 output from the first output terminal OUT1 and the effective pulse of a second gate signal S2 output from the second output terminal OUT2 are sequentially shifted.

It is to be understood that n is a positive integer greater than or equal to 2, that is, two or more shift register units 101 may be provided in the driver circuit 10. The specific number of shift register units 101 may be designed according to actual requirements, which is specifically not limited in the embodiments of the present disclosure.

The display panel 100 may include a display region AA and a non-display region NA surrounding the display region AA. The driver circuit 10 may be provided in the non-display region NA. Multiple pixel circuits 20 arranged in an array and multiple gate signal lines 30 may be provided in the display region AA. The gate signal lines 30 may include first gate signal lines 31 and second gate signal lines 32. A pixel circuit 20 may be electrically connected to a first gate signal line 31 and a second gate signal line 32. Additionally, at least some of the pixel circuits 20 in the same row are electrically connected to the same first gate signal line 31, and at least some of the pixel circuits 20 in the same row are electrically connected to the same second gate signal line 32. In this case, the first output terminals OUT1 of the stages of shift register units 101 are electrically connected to different first gate signal lines 31 and the second output terminals OUT2 of the stages of shift register units 101 are electrically connected to different second gate signal lines 32 to enable the stages of shift register units 101 to output first gate signals S1 to the corresponding first gate signal lines 31 and second gate signals S2 to the corresponding second gate signal lines 32. In this manner, the first gate signal lines 31 may transmit the first gate signals S1 output by the stages of shift register units 101 to the rows of pixel circuits 20, and the second gate signal lines 32 may transmit the second gate signals S2 output by the stages of shift register units 101 to rows of pixel circuits 20 to achieve the progressive scanning on the pixel circuits 20 and allow corresponding display signals to be written to the rows of pixel circuits 20 to control the rows of pixel circuits 20 to display and emit light, thereby enabling the display panel 100 to present corresponding images.

It is to be noted that the above is only illustrated using an example in which the driver circuit 10 is located in the non-display region NA and the pixel circuits 20 are located in the display region AA, while in other embodiments of the present disclosure, the pixel circuits 20 and the driver circuit 10 may all be provided in the display region AA to enable the number of devices provided in the non-display region NA of the display panel 100 to be sufficiently small and reduce the size of the non-display region NA of the display panel 100, thereby facilitating the implementation of the narrow-bezel design of the display panel 100 and allowing the display panel 100 to have a higher screen-to-body ratio.

For ease of description, unless special limitations are made, the technical solutions in the embodiments of the present disclosure are illustrated using an example in which the driver circuit is located in the non-display region of the display panel and the pixel circuits are located in the display region of the display panel in the embodiments of the present disclosure.

With continued reference to FIGS. 3 and 4, in the same shift register unit 101, the scan control module 110 is electrically connected to the forward input terminal INF, the reverse input terminal INB, the forward control terminal U2D, the reverse control terminal D2U and the input node Q0 so that the scan control module 110 may control the signal of the input node Q0 according to a forward scan control signal u2d of the forward control terminal U2D, a reverse scan control signal d2u of the reverse control terminal D2U, a forward input signal Vinf of the forward input terminal INF and a reverse input signal Vinb of the reverse input terminal INB.

In an example embodiment, the scan control module 110 may control a transmission path through which the forward input signal Vinf of the forward input terminal INF is transmitted to the input node Q0 according to the forward scan control signal u2d of the forward control terminal U2D so that when the forward scan control signal u2d is at an effective level, the scan control module 110 may control the forward input signal Vinf of the forward input terminal INF to be transmitted to the input node Q0. Furthermore, the scan control module 110 may also control a transmission path through which the reverse input signal Vinb of the reverse input terminal INB is transmitted to the input node Q0 according to the reverse scan control signal d2u of the reverse control terminal D2U so that when the reverse scan control signal d2u is at an effective level, the scan control module 110 may control the reverse input signal Vinb of the reverse input terminal INB to be transmitted to the input node Q0.

It is to be understood that, on the premise that the scan control module 110 may control the signal of the input node Q0, the specific implementation of the scan control module 110 is not limited in the embodiments of the present disclosure. During image display on the display panel, the polarities of the forward scan control signal u2d and the reverse scan control signal d2u may be opposite to ensure that the scan control module 110 operates normally.

In an optional embodiment, the operating mode of the display panel 100 includes a forward scan mode and a reverse scan mode. In the forward scan mode, the forward scan control signal u2d may be at an effective level, and the reverse scan control signal d2u may be at an ineffective level. In the reverse scan mode, the reverse scan control signal d2u is at an effective level, and the forward scan control signal u2d is at an ineffective level. In this manner, in the forward scan mode, the forward input signal Vinf of the forward input terminal INF can be transmitted to the input node Q0 under the control of the forward scan control signal u2d while the reverse input signal Vinb of the reverse input terminal INB cannot be transmitted to the input node Q0 so that the signal of the input node Q0 may be consistent with the forward input signal Vinf; in the reverse scan mode, the reverse input signal Vinb of the reverse input terminal INB can be transmitted to the input node Q0 under the control of the reverse scan control signal d2u while the forward input signal Vinf of the forward input terminal INF cannot be transmitted to the input node Q0 so that the signal of the input node Q0 may be consistent with the reverse input signal Vinb.

With continued reference to FIGS. 3 and 4, since the drive control module 120 is at least electrically connected to the input node Q0, the first clock terminal CK1, the first node Q1 and the second node Q2 in the same shift register unit 101, the drive control module 120 may control a signal of the first node Q1 and a signal of the second node Q2 according to the signal of the input node Q0 and a first clock signal ck1 of the first clock terminal CK1. For example, when both the signal of the input node Q0 and the first clock signal ck1 are at effective levels, the signal of the first node Q1 may be controlled to at an effective level, and the signal of the second node Q2 may be controlled to at an ineffective level; within at least part of the duration when the signal of the first node Q1 is at an ineffective level, the signal of the first node Q1 may be controlled to at an ineffective level, and the signal of the second node Q2 may be controlled to at an effective level. In this manner, the signal of the first node Q1 and the signal of the second node Q2 may have different polarities within at least part of the duration.

Furthermore, since the first output module 130 is at least electrically connected to the first node Q1, the second node Q2, the second clock terminal CK2 and the first output terminal OUT1 in the same shift register unit 101, the first output module 130 can control the first gate signal S1 output from the first output terminal OUT1 according to the signal of the first node Q1, the signal of the second node Q2 and a second clock signal ck2 of the second clock terminal CK2. For example, when both the signal of the first node Q1 and the second clock signal ck2 are at effective levels and the signal of the second node Q2 is at an ineffective level, the first output module 130 may control the first output terminal OUT1 to output the effective level of the first gate signal S1; otherwise, the first output module 130 may control the first output terminal OUT1 to output the ineffective level of the first gate signal S1. Since the second output module 140 is at least electrically connected to the first node Q1, the second node Q2, the third clock terminal CK3 and the second output terminal OUT2 in the same shift register unit 101, the second output module 140 may control the second gate signal S2 output from the second output terminal OUT2 according to the signal of the first node Q1, the signal of the second node Q2 and a third clock signal ck3 of the third clock terminal CK3. For example, when both the signal of the first node Q1 and the third clock signal ck3 are at effective levels and the signal of the second node Q2 is at an ineffective level, the second output module 140 may control the second output terminal OUT2 to output the effective level of the second gate signal S2; otherwise, the second output module 140 may control the second output terminal OUT2 to output the ineffective level of the second gate signal S2. In this manner, both the first output module 130 and the second output module 140 may output gate drive signals under the control of the signal of the first node Q1 and the signal of the second node Q2, and the first gate signal S1 output from the first output terminal OUT1 under the control of the first output module 130 and the second gate signal S2 output from the second output terminal OUT2 under the control of the second output module 140 may be the same or different, which may be specifically determined according to the second clock signal ck2 received by the first output module 130 and the third clock signal ck3 received by the second output module 140. For example, when the effective pulses of the second clock signal ck2 and the third clock signal ck3 are sequentially shifted within one clock cycle, the effective pulses of the first gate signal S1 and the second gate signal S2 may be sequentially shifted. In this case, the same shift register unit 101 may output two different gate drive signals simultaneously, and when 2n different gate drive signals are required, only n shift register units 101 need to be provided in the driver circuit 10, thereby reducing the number of shift register units 101 in the driver circuit 10 and reducing the size of the driver circuit 10. When the driver circuit 10 is provided in the non-display region NA of the display panel 100, the size of the non-display region NA of the display panel 100 may be reduced, thereby facilitating the implementation of the narrow-bezel design of the display panel 100.

It is to be understood that each of the first clock signal ck1, the second clock signal ck2 and the third clock signal ck3 includes a high level and a low level that change with a certain clock cycle, the effective levels of the first clock signal ck1, the second clock signal ck2 and the third clock signal ck3 may be high or low, and the effective levels of the first clock signal ck1, the second clock signal ck2 and the third clock signal ck3 may be the same or different, which may be specifically designed according to actual requirements. The technical solutions of the embodiments of the present disclosure are illustrated using an example in which the effective levels of the first clock signal ck1, the second clock signal ck2 and the third clock signal ck3 are low in the embodiments of the present disclosure. Furthermore, the first clock signal ck1, the second clock signal ck2 and the third clock signal ck3 remain at effective levels during the durations of the effective pulses of the first clock signal ck1, the second clock signal ck2 and the third clock signal ck3 respectively, and the first clock signal ck1, the second clock signal ck2 and the third clock signal ck3 remain at ineffective levels during the remaining time periods. Additionally, the durations of the effective pulses of the first clock signal ck1, the second clock signal ck2 and the third clock signal ck3 do not overlap, which may be specifically designed according to actual requirements and is not specifically limited in the embodiments of the present disclosure.

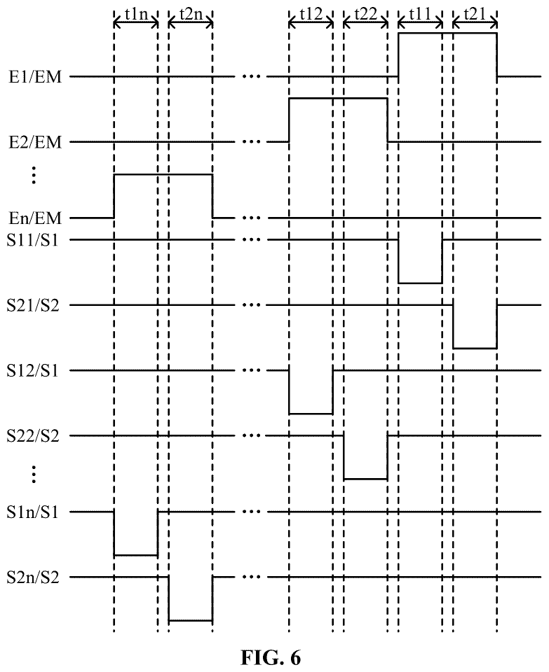

FIG. 5 is a drive timing diagram of a display panel according to an embodiment of the present disclosure, and FIG. 6 is a driving timing diagram of another display panel according to an embodiment of the present disclosure. With reference to FIGS. 3 to 6, the first output terminal OUT1 or the second output terminal OUT2 of an x^{th}-stage shift register unit Gx is electrically connected to the forward input terminal INF of a y^{th}-stage shift register unit Gy, and the reverse input terminal INB of the y^{th}-stage shift register unit Gy is electrically connected to the first output terminal OUT1 or the second output terminal OUT2 of a k^{th}-stage shift register unit Gk, where 1≤x<y<k≤n, and x, y and k are positive integers. In this case, the operating mode of the display panel 100 may include a forward scan mode and a reverse scan mode. In the forward scan mode, a first-stage shift register unit G1 to an n^{th}-stage shift register unit Gn sequentially output the effective pulse of the first gate signal S1 and sequentially output the effective pulse of the second gate signal S2. In the reverse scan mode, the n^{th}-stage shift register unit Gn to the first-stage shift register unit G1 sequentially output the effective pulse of the first gate signal S1 and sequentially output the effective pulse of the second gate signal S2.

The x^{th}-stage shift register unit Gx, the y^{th}-stage shift register unit Gy and the k^{th}-stage shift register unit Gk may be three adjacent stages of shift register units 101. For example, when x is equal to i, y may be equal to i+1, and k may be equal to i+2. Alternatively, the x^{th}-stage shift register unit Gx, the y^{th}-stage shift register unit Gy and the k^{th}-stage shift register unit Gk may be three non-adjacent stages of shift register units 101. For example, when x is equal to i, y may be equal to i+2, and k may be equal to i+4. On the premise that the core inventive points in the embodiments of the present disclosure are achieved, the values of x, y and k are not specifically limited in the embodiments of the present disclosure.

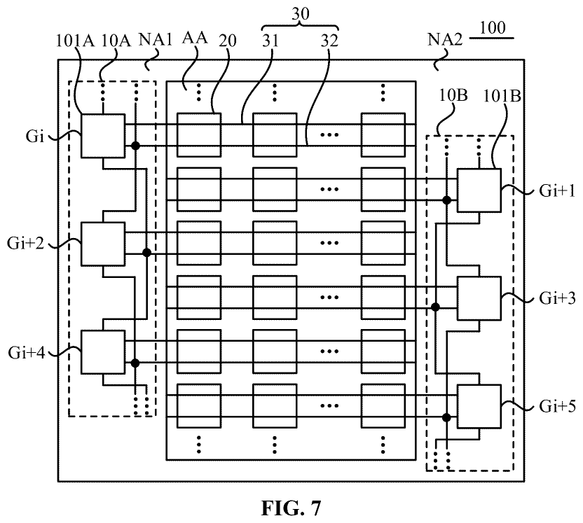

In an optional embodiment, FIG. 7 is a structure diagram of another display panel according to an embodiment of the present disclosure. As shown in FIG. 7, the display panel 100 may include a display region AA and a non-display region at least partially surrounding the display region AA, and the non-display region may include a first non-display region NA1 and a second non-display region NA2 on opposite sides of the display region AA. When x=y−m, k=y+m, and m is a positive integer greater than 1, stages of shift register units (101A or 101B) cascaded with each other constitute a driver sub-circuit (10A or 10B). Part of the driver sub-circuit (10A) is in the first non-display region NA1, and part of the driver sub-circuit (10B) is in the second non-display region NA2.

M is a positive integer greater than 1, that is, m may be any positive integer, such as 2, 3 or more. For example, if m is equal to 2, shift register units 101A (Gi, Gi+2 and Gi+4) in odd-numbered stages may constitute a first driver sub-circuit 10A, and shift register units 101B (Gi+1, Gi+3 and Gi+5) in even-numbered stages may constitute a second driver sub-circuit 10B, where i is an odd number. The first driver sub-circuit 10A may be provided in the first non-display region NA1, and the second driver sub-circuit 10B may be provided in the second non-display region NA2.

In an optional embodiment, in the first driver sub-circuit 10A, the forward input terminal INF of the (i+2)^{th}-stage register unit Gi+2 may be electrically connected to the second output terminal OUT2 of the i^{th}-stage shift register unit Gi, and the reverse input terminal INB of the (i+2)^{th}-stage register unit Gi+2 may be electrically connected to the second output terminal OUT2 of the (i+4)^{th}-stage register unit Gi+2. In this manner, in the forward scan mode, under the control of the second gate signal S2i of the i^{th}-stage shift register unit Gi and the clock signals received by the (i+2)^{th}-stage register unit Gi+2, the durations of the effective pluses of the first gate signal S1i+2 and the second gate signal S2i+2 output by the (i+2)^{th}-stage register unit Gi+2 are controlled to ensure that the durations of the effective pluses of the first gate signal S1i+2 and the second gate signal S2i+2 output by the (i+2)^{th}-stage register unit Gi+2 are after the duration of the effective pulse of the second gate signal S2i of the i^{th}-stage shift register unit Gi. In the reverse scan mode, under the control of the second gate signal S2i+4 of the (i+4)^{th}-stage shift register unit Gi+4 and the clock signals received by the (i+2)^{th}-stage register unit Gi+2, the durations of the effective pluses of the first gate signal S1i+2 and the second gate signal S2i+2 output by the (i+2)^{th}-stage register unit Gi+2 are controlled to ensure that the durations of the effective pluses of the first gate signal S1i+2 and the second gate signal S2i+2 output by the (i+2)^{th}-stage register unit Gi+2 are after the duration of the effective pulse of the second gate signal S2i+4 of the (i+4)^{th}-stage shift register unit Gi+4.

Correspondingly, in the second driver sub-circuit 10B, the forward input terminal INF of the (i+3)^{th}-stage register unit Gi+3 may be electrically connected to the second output terminal OUT2 of the (i+1)^{th}-stage shift register unit Gi+1, and the reverse input terminal INB of the (i+3)^{th}-stage register unit Gi+3 may be electrically connected to the second output terminal OUT2 of the (i+5)^{th}-stage register unit Gi+5. In this manner, in the forward scan mode, under the control of the second gate signal S2i+1 of the (i+1)^{th}-stage shift register unit Gi+1 and the clock signals received by the (i+3)^{th}-stage register unit Gi+3, the durations of the effective pluses of the first gate signal S1i+3 and the second gate signal S2i+3 output by the (i+3)^{th}-stage register unit Gi+3 are controlled to ensure that the durations of the effective pluses of the first gate signal S1i+3 and the second gate signal S2i+3 output by the (i+3)^{th}-stage register unit Gi+3 are after the duration of the effective pulse of the second gate signal S2i+1 of the (i+1)^{th}-stage shift register unit Gi+1. In the reverse scan mode, under the control of the second gate signal S2i+5 of the (i+5)^{th}-stage shift register unit Gi+5 and the clock signals received by the (i+3)^{th}-stage register unit Gi+3, the durations of the effective pluses of the first gate signal S1i+3 and the second gate signal S2i+3 output by the (i+3)^{th}-stage register unit Gi+3 are controlled to ensure that the durations of the effective pluses of the first gate signal S1i+3 and the second gate signal S2i+3 output by the (i+3)^{th}-stage register unit Gi+3 are after the duration of the effective pulse of the second gate signal S2i+5 of the (i+5)^{th}-stage shift register unit Gi+5.

In the forward scan mode, the duration of the effective pulse of the first gate signal S1i output by the i^{th}-stage shift register unit Gi may be before the duration of the effective pulse of the first gate signal S1i+1 output by the (i+1)^{th}-stage shift register unit Gi+1, and the duration of the effective pulse of the second gate signal S2i output by the i^{th}-stage shift register unit Gi may be before the duration of the effective pulse of the second gate signal S2i+1 output by the (i+1)^{th}-stage shift register unit Gi+1; the duration of the effective pulse of the first gate signal S1i+1 output by the (i+1)^{th}-stage shift register unit Gi+1 may be before the duration of the effective pulse of the first gate signal S1i+2 output by the (i+2)^{th}-stage shift register unit Gi+2, and the duration of the effective pulse of the second gate signal S2i+1 output by the (i+1)^{th}-stage shift register unit Gi+1 may be before the duration of the effective pulse of the second gate signal S2i+2 output by the (i+2)^{th}-stage shift register unit Gi+2; similarly, the duration of the effective pulse of the second gate signal S2i+4 output by the (i+4)^{th}-stage shift register unit Gi+4 may be before the duration of the effective pulse of the second gate signal S2i+5 output by the (i+5)^{th}-stage shift register unit Gi+5. When the shift register unit (101A or 101B) in each stage is electrically connected to one row of pixel circuits 20, serpentine scanning on the pixel circuits 20 in the first row to the last row may be achieved, thereby enhancing the display uniformity of the pixel circuits 20 and improving the display performance of the display panel.

Correspondingly, in the reverse scan mode, when the shift register unit (101A or 101B) in each stage is electrically connected to one row of pixel circuits 20, serpentine scanning on the pixel circuits 20 in the last row to the first row may also be achieved, thereby enhancing the display uniformity of the pixel circuits 20 and improving the display performance of the display panel.

Additionally, by providing the first driver sub-circuit 10A and the second driver sub-circuit 10B in the first non-display region NA1 and the second non-display region NA2 on opposite sides of the display region AA, respectively, the sizes of the first non-display region NA1 and the second non-display region NA2 on opposite sides of the display region AA are kept consistent, and the display bezels on opposite sides of the display region AA in the display panel 100 are symmetrical, thereby improving the aesthetic appearance of the display panel 100 on the premise of ensuring the display performance of the display panel 100.

It is to be noted that the arrangement of various stages of shift register units is illustrated using an example in which m is equal to 2, and the specific arrangement of the various stages of shift register units in the embodiments of the present disclosure is not limited thereto, which may be specifically designed according to actual requirements and is not specifically limited in the embodiments of the present disclosure.

With continued reference to FIGS. 3 to 6, since the first output terminal OUT1 or the second output terminal OUT2 of the x^{th}-stage shift register unit Gx is electrically connected to the forward input terminal INF of the y^{th}-stage shift register unit Gy, the first gate signal S1 output from the first output terminal OUT1 or the second gate signal S2 output from the second output terminal OUT2 of the x^{th}-stage shift register unit Gx may be used as the forward input signal Vinf of the forward input terminal INF of the y^{th}-stage shift register unit Gy. In this manner, in the forward scan mode, through the first gate signal S1 or the second gate signal S2 output by the x^{th}-stage shift register unit Gx and the forward scan control signal u2d of the forward control terminal U2D of the y^{th}-stage shift register unit Gy, the signal of the input node Q0 of the y^{th}-stage shift register unit Gy may be controlled, and then the first gate signal S1 and the second gate signal S2 output by the y^{th}-stage shift register unit Gy may be controlled. Furthermore, since the reverse input terminal INB of the y^{th}-stage shift register unit Gy is electrically connected to the first output terminal OUT1 or the second output terminal OUT2 of the k^{th}-stage shift register unit Gk, the first gate signal S1 output from the first output terminal OUT1 or the second gate signal S2 output from the second output terminal OUT2 of the k^{th}-stage shift register unit Gk may be used as the reverse input signal Vinb of the reverse input terminal INB of the y^{th}-stage shift register unit Gy. In this manner, in the reverse scan mode, through the first gate signal S1 or the second gate signal S2 output by the k^{th}-stage shift register unit Gk and the reverse scan control signal d2u of the reverse control terminal D2U of the y^{th}-stage shift register unit Gy, the signal of the input node Q0 of the y^{th}-stage shift register unit Gy may be controlled, and then the first gate signal S1 and the second gate signal S2 output by the y^{th}-stage shift register unit Gy may be controlled. Therefore, by setting the connection between the y^{th}-stage shift register unit Gy and the x^{th}-stage shift register unit Gx and the k^{th}-stage shift register unit Gk, the driver circuit 10 can meet requirements in different operating modes of the display panel 100, that is, the driver circuit 10 can meet the requirements of the forward scan mode and the reverse scan mode of the display panel 100, thereby meeting diversified application requirements.

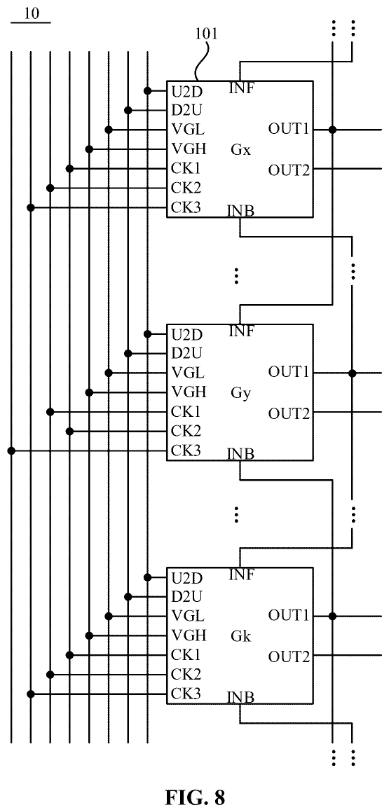

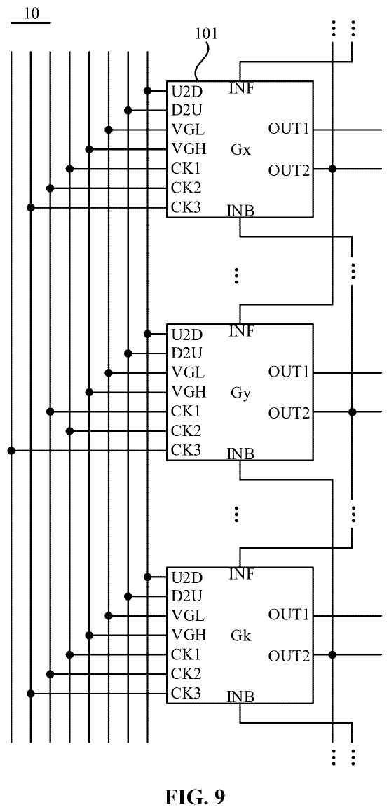

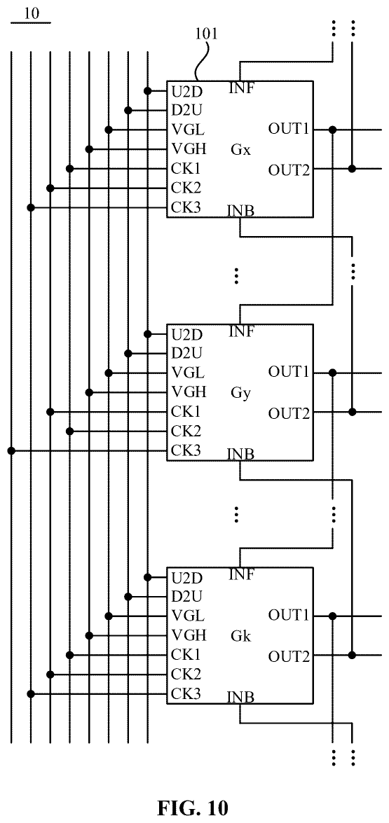

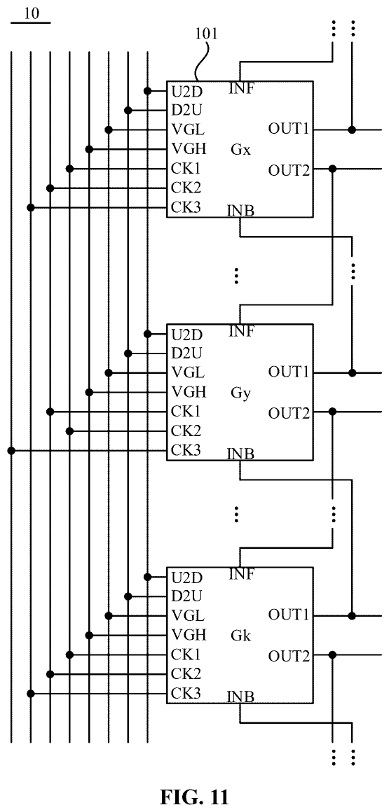

It is to be understood that in the embodiments of the present disclosure, the setting in which the first output terminal OUT1 or the second output terminal OUT2 of the x^{th}-stage shift register unit Gx is electrically connected to the forward input terminal INF of the y^{th}-stage shift register unit Gy may be that, as shown in FIGS. 8 and 10, the first output terminal OUT1 of the x^{th}-stage shift register unit Gx is electrically connected to the forward input terminal INF of the y^{th}-stage shift register unit Gy or that, as shown in FIGS. 9 and 11, the second output terminal OUT2 of the x^{th}-stage shift register unit Gx is electrically connected to the forward input terminal INF of the y^{th}-stage shift register unit Gy. Correspondingly, the setting in which the reverse input terminal INB of the y^{th}-stage shift register Gy unit is electrically connected to the first output terminal OUT1 or the second output terminal OUT2 of the k^{th}-stage shift register unit Gk may be that, as shown in FIGS. 8 and 11, the reverse input terminal INB of the y^{th}-stage shift register Gy unit is electrically connected to the first output terminal OUT1 of the k^{th}-stage shift register unit Gk or that, as shown in FIGS. 9 and 10, the reverse input terminal INB of the y^{th}-stage shift register Gy unit is electrically connected to the second output terminal OUT2 of the k^{th}-stage shift register unit Gk. The specific connection manner may be designed according to actual requirements and is not specifically limited in the embodiments of the present disclosure. For ease of description, unless special limitations are made, the technical solutions in the embodiments of the present disclosure are illustrated using the cascade manner shown in FIG. 8 or 9 as an example in the embodiments of the present disclosure.

It is also to be understood that the effective pulses of the first gate signal S1 and the second gate signal S2 output by the same shift register unit 101 are sequentially shifted in both the forward scan mode and the reverse scan mode, that is, for the same shift register unit 101, in both the forward scan mode and the reverse scan mode, the start time of the effective pulse of the first gate signal S1 is before the start time of the effective pulse of the second gate signal S2, and the end time of the effective pulse of the first gate signal S1 is before the end time of the effective pulse of the second gate signal S2. Furthermore, the width of the effective pluses of the first gate signal S1 and the second gate signal S2 of the same shift register unit 101 may be the same or different, which may be specifically designed according to actual requirements and is not specifically limited in the embodiments of the present disclosure.

Additionally, since the effective pulses of the first gate signal S1 and the second gate signal S2 output by the same shift register unit 101 are sequentially shifted, one stage of shift register units 101 may supply two gate signals to the corresponding pixel circuits 20. In this case, the first output terminal OUT1 and the second output terminal OUT2 of the same shift register unit 101 may be electrically connected to different rows of pixel circuits 20, respectively, to enable the stages of shift register units 101 to control the operating processes of at least two rows of pixel circuits 20; or, the first output terminal OUT1 and the second output terminal OUT2 of the same shift register unit 101 may also be electrically connected to different modules in the same pixel circuit 20 to control the on/off states of different modules in the same pixel circuit 20; or, when the first output terminal OUT1 and the second output terminal OUT2 of the same shift register unit 101 are electrically connected to different modules of the same pixel circuit 20, respectively, the pixel circuit 20 may at least include a first preset module and a second preset module; in this case, the first output terminal OUT1 may be electrically connected to the first preset modules of two adjacent rows of pixel circuits 20, and the second output terminal OUT2 may be electrically connected to the second preset modules of the two adjacent rows of pixel circuits 20.

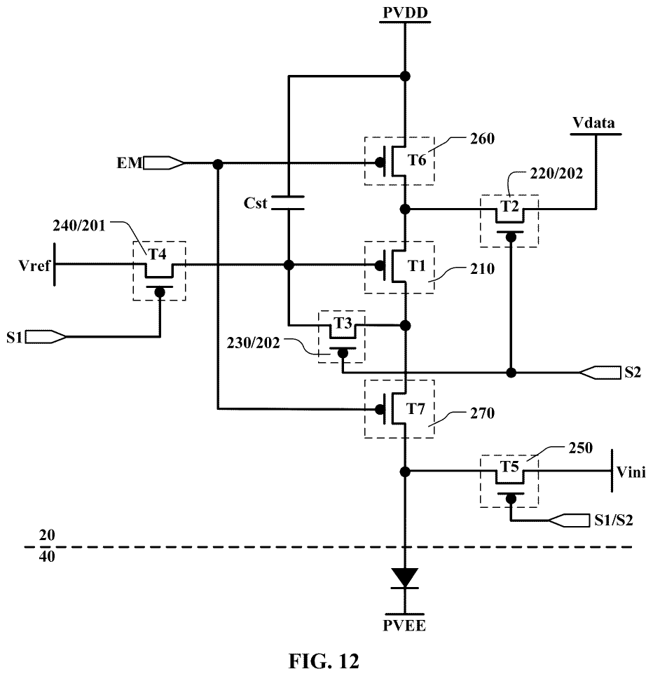

In an optional embodiment, FIG. 12 is a structure diagram of a pixel circuit according to an embodiment of the present disclosure. With reference to FIGS. 3 and 12, when the display panel 100 includes a display region AA, the display region AA is provided with multiple pixel circuits 20 arranged in an array and the pixel circuit 20 at least includes a first preset module 201 and a second preset module 202, the first gate signal S1 and the second gate signal S2 of the same shift register unit 101 are configured to control the first preset module 201 and the second preset module 202 of the same pixel circuit 20 to be turned on or off, respectively, that is, the first gate signal S1 of the shift register unit 101 may control the first preset module 201 to supply corresponding signals to the nodes electrically connected thereto, and the second gate signal S2 of the shift register unit 101 may control the second preset module 202 to supply corresponding signals to the nodes electrically connected thereto, thereby achieving the control of the driving process of the pixel circuit 20. Therefore, there is no need to additionally provide corresponding shift register units 101 for the first preset module 201 and the second preset module 202 of the pixel circuit 20, respectively, thereby reducing the number of shift register units 101 provided in the driver panel 100, reducing the size of the driver circuit 10, and facilitating the implementation of the narrow-bezel design of the display panel 100.

It is to be understood that the first preset module 201 and the second preset module 202 may include active and/or passive devices. The active devices, for example, may be transistors, and the passive devices, for example, may be capacitors, resistors, inductors or the like. In the case where the first preset module 201 includes a p-channel metal-oxide-semiconductor (PMOS) transistor, when the first gate signal S1 is a low-level signal, the first gate signal S1 is an effective pulse, that is, the effective level of the first gate signal S1 is low, and then the low-level first gate signal S1 may control the PMOS transistor to be turned on; when the first gate signal S1 is a high-level signal, the first gate signal S1 is at an ineffective level, and then the high-level first gate signal S1 may control the PMOS transistor to be turned off. Conversely, when the first preset module 201 includes an n-channel metal-oxide-semiconductor (NMOS) transistor, the high-level first gate signal S1 may control the NMOS transistor to be turned on, and the low-level first gate signal S1 may control the NMOS transistor to be turned off. In the case where the second preset module 202 includes a PMOS or NMOS transistor, the second gate signal S2 is of a similar situation to the first gate signal S1. For specifics, reference may be made to the above description, which is not specifically limited here. For ease of description, unless special limitations are made, the technical solutions in the embodiments of the present disclosure are illustrated using an example in which all the transistors in the first preset module 201 and the second preset module 202 are PMOS transistors in the embodiments of the present disclosure.

It is also to be understood that the first preset module and the second preset module of the pixel circuit may be any modules in the pixel circuit and may be selected according to actual requirements. The pixel circuit and the preset modules thereof mentioned in the embodiments of the present disclosure are illustrated below using typical examples.

In an optional embodiment, as shown in FIG. 12, the pixel circuit 20 may include a drive module 210, a data write module 220, a compensation module 230 and a reset module 240. The drive module 210 may include a drive transistor T1. The data write module 220 is electrically connected to a first electrode of the drive transistor T1. The compensation module 230 is electrically connected between a second electrode of the drive transistor T1 and a gate of the drive transistor T1. The reset module 240 is electrically connected to the gate of the drive transistor T1.

The display panel 100 may further include multiple light-emitting elements 40, and the pixel circuits 20 may be electrically connected to the light-emitting elements 40 correspondingly. The drive module 210 may selectively supply a drive current to the light-emitting element 40 to drive the light-emitting element 40 to emit light. The data write module 220 is configured to supply a data signal Vdata to the drive module 210 to enable the drive module 210 to generate the drive current for driving the light-emitting element 40 to emit light according to the data signal Vdata. The reset module 240 is configured to supply a reset signal to the drive module 210 to reset the drive module 210. The compensation module 230 is configured to compensate the data signal Vdata when the data write module 220 supplies the data signal Vdata to the drive module 210 to ensure that the drive module 210 can supply an accurate drive current to the light-emitting element 40, thereby controlling the light emission accuracy of the light-emitting element 40.

It is to be understood that, since the light-emitting element 40 is generally a current-mode drive element while the data signal Vdata supplied by the data write module 220 is generally a voltage signal, by providing the drive transistor T1 in the drive module 210 to write the data signal Vdata supplied by the data write module 220 to the gate of the drive transistor T1, the drive transistor T1 may generate a corresponding drive current according to the signal from the gate of the drive transistor T1 and supply the drive current to the light-emitting element 40 to drive the light-emitting element 40 to emit light with corresponding brightness. In this case, one of the source or the drain of the drive transistor T1 receives a positive power signal PVDD, the other is coupled to the anode of the light-emitting element 40, and the cathode of the light-emitting element 40 may receive a negative power signal PVEE. In this manner, a voltage difference occurs between the positive power signal PVDD and the negative power signal PVEE, and then a current path is formed so that the drive transistor T1 may generate a drive current and supply the drive current to the light-emitting element 40 to drive the light-emitting element 40 to emit light.

With continued reference to FIG. 12, the drive cycle of the pixel circuit 20 may sequentially include a reset stage, a write stage and a light emission stage. In the reset stage, the reset module 240 may supply a reset signal Vref to the gate of the drive transistor T1 to reset the gate of the drive transistor T1. In the write stage, the data write module 220 may supply a data signal Vdata to the drive transistor T1, and meanwhile, the compensation module 230 may supplement the threshold voltage of the drive transistor T1 to the gate of the drive transistor T1. In the light emission stage, the drive module 210 may supply a drive current to the light-emitting element 40 according to the signal at the gate of the drive transistor T1 to drive the light-emitting element 40 to emit light.

The control terminal of the reset module 240 may receive a first scan signal, and the first scan signal controls the reset module 240 to be turned on or off and may control the reset module 240 to be turned on during the duration of the effective pulse of the first scan signal to enable the reset module 240 to write the reset signal Vref to the gate of the drive transistor T1. The control terminal of the data write module 220 may receive a second scan signal, and the second scan signal controls the data write module 220 to be turned on or off and may control the data write module 220 to be turned on during the duration of the effective pulse of the second scan signal to enable the data write module 220 to control the data signal Vdata to be written to the drive module 210. The control terminal of the compensation module 230 may receive a third scan signal, and the third scan signal may control the compensation module 230 to be turned on or off and may control the compensation module 230 to be turned on during the duration of the effective pulse of the third scan signal to enable the compensation module 230 to supply the threshold voltage Vth of the drive transistor T1 to the gate of the drive transistor T1 as compensation.

With reference to FIGS. 3, 4 and 12, the first preset module 201 may include the reset module 240, and the second preset module 202 may include the data write module 220 and/or the compensation module 230. In this case, the first gate signal S1 may serve as the first scan signal, and the second gate signal S2 may serve as the second scan signal and/or the third scan signal, that is, the reset modules 240 of at least part of the pixel circuits 20 in the same row may be electrically connected to the same first gate signal line 31 and the data write modules 220 and/or the compensation modules 230 of at least part of the pixel circuits 20 in the same row may be electrically connected to the same second gate signal line 32. Therefore, the first gate signal S1 transmitted by the first gate signal line 31 may control the reset module 240 to be turned on or off, and the second gate signal S2 transmitted by the second gate signal line 32 may control the data write module 220 and/or the compensation module 230 to be turned on or off. Since the effective pulses of the first gate signal S1 and the second gate signal S2 output by the same shift register unit 101 are sequentially shifted, that is, the duration of the effective pulse of the first gate signal S1 is before the duration of the effective pulse of the second gate signal S2, the turn-on duration of the reset module 240 is before the turn-on duration of the data write module 220 and/or the compensation module 230 within one drive cycle of the pixel circuit 20. In this manner, after the reset module 240 resets the drive transistor T1, the data signal Vdata and the threshold voltage of the drive transistor T1 are written to the gate of the drive transistor T1 through the data write module 220 and the compensation module 230 so that the pixel circuit 20 may operate normally and may accurately supply the drive current to the light-emitting element 40 in the subsequent light emission stage to enable the light-emitting element 40 to accurately emit light.

In an optional embodiment, the reset module 240 includes a reset transistor T4. A first electrode of the reset transistor T4 receives a reset signal Vref, a second electrode of the reset transistor T4 is electrically connected to the gate of the drive transistor T1, and a gate of the reset transistor T4 receives the first gate signal S1 so that the first gate signal S1 controls the reset transistor T4 to be turned on or off. The data write module 220 may include a data write transistor T2. A first electrode of the data write transistor T2 receives the data signal Vdata, a second electrode of the data write transistor T2 is electrically connected to the first electrode of the drive transistor T1, and a gate of the data write transistor T2 receives the second gate signal S2 so that the second gate signal S2 controls the data write transistor T2 to be turned on or off. The compensation module 230 includes a compensation transistor T3. A first electrode of the compensation transistor T3 is electrically connected to the second electrode of the drive transistor T1, a second electrode of the compensation transistor T3 is electrically connected to the gate of the drive transistor T1, and a gate of the compensation transistor T3 receives the second gate signal S2 so that the second gate signal S2 controls the compensation transistor T3 to be turned on or off.

On the basis of the above embodiments, optionally, the pixel circuit 20 may further include an initialization module 250. The initialization module 250 is connected to the anode of the light-emitting element 40 and configured to supply an initialization signal Vini to the light-emitting element 40 to initialize the anode of the light-emitting element 40. The initialization module 250 may be turned on or off under the control of a fourth scan signal, and when the fourth scan signal controls the initialization module 250 to be turned on, the initialization signal Vini may be supplied to the anode of the light-emitting element 40. Before the light-emitting element 40 emits light, the anode of the light-emitting element 40 may be initialized by the initialization module 250, and in this case, the first gate signal S1 or the second gate signal S2 may also serve as the fourth scan signal to control the initialization module 250 to be turned on or off.

In an optional embodiment, the initialization module 250 may include an initialization transistor T5. A first electrode of the initialization transistor T5 receives the initialization signal Vini, a second electrode of the initialization transistor T5 is electrically connected to the anode of the light-emitting element 40, and a gate of the initialization transistor T5 receives the first gate signal S1 or the second gate signal S2 so that the first gate signal S1 or the second gate signal S2 may control the initialization transistor T5 to be turned on or off.

On the basis of the above embodiments, optionally, the pixel circuit 20 may further include a light emission control module. The light emission control module may include a first light emission control module 260 and a second light emission control module 270. The first light emission control module 260 and the second light emission control module 270 may control a current path between the positive power signal PVDD and the negative power signal PVEE to control the duration when the drive transistor T1 supplies the drive current to the light-emitting element 40. The first light emission control module 260 and the second light emission control module 270 may be turned on or off under the control of a light emission control signal EM. When the light emission control signal EM controls the first light emission control module 260 and the second light emission control module 270 to be turned on, the drive transistor T1 may generate a drive current and supply the drive current to the light-emitting element 40 to drive the light-emitting element 40 to emit light.

In an optional embodiment, the first light emission control module 260 may include a first light emission control transistor T6, and the second light emission control module 270 may include a second light emission control transistor T7. A first electrode of the first light emission control transistor T6 receives the positive power signal PVDD, a second electrode of the first light emission control transistor T6 is electrically connected to the first electrode of the drive transistor T1, a first electrode of the second light emission control transistor T7 is electrically connected to the second electrode of the drive transistor T1, a second electrode of the second light emission control transistor T7 is electrically connected to the anode of the light-emitting element 40, and both a gate of the first light emission control transistor T6 and a gate of the second light emission control transistor T7 receive the light emission control signal EM so that the light emission control signal EM may control the first light emission control transistor T6 and the second light emission control transistor T7 to be simultaneously turned on or off.

On the basis of the above embodiments, the pixel circuit 20 may further include a storage capacitor Cst. A first plate of the storage capacitor Cst receives a fixed signal (such as the positive power signal PVDD), and a second plate of the storage capacitor Cst is electrically connected to the gate of the drive transistor T1 to store the signal at the gate of the drive transistor T1.

It is to be noted that the structure of the pixel circuit 20 is illustrated in FIG. 12 only by way of example, and the structure of the pixel circuit 20 is not limited here. On the premise that the core inventive points in the embodiments of the present disclosure are achieved, the specific structure of the pixel circuit is not specifically limited in the embodiments of the present disclosure.

Based on the above-described pixel circuit, the first gate signal S1 output from the first output terminal OUT1 of the shift register unit 101 in the embodiments of the present disclosure may control the reset module 240 to be turned on and off or the first gate signal S1 output from the first output terminal OUT1 may simultaneously control the reset module 240 and the initialization module 250 to be turned on and off, and the second gate signal S2 output from the second output terminal OUT2 of the shift register unit 101 may only control the data write module 220 or the compensation module 230 to be turned on or off or the second gate signal S2 output from the second output terminal OUT2 may simultaneously control the data write module 220 and the compensation module 230 to be turned on or off. The driving principle of the pixel circuit 20 is described below using an example in which the first gate signal S1 is configured to control the reset module 240 and the initialization module 250 to be turned on or off and the second gate signal S2 is configured to control the data write module 220 and the compensation module 230 to be turned on or off.

With reference to FIGS. 3, 4, 5 and 12, when the operating mode of the display panel 100 is the forward scan mode, the first-stage shift register unit G1 to the n^{th}-stage shift register unit Gn supply the first gate signals S1 to the reset modules 240 and the initialization modules 250 of the pixel circuits 20 in the first row to the n^{th} row and supply the second gate signals S2 to the data write modules 220 and the compensation modules 230 of the pixel circuits 20 in the first row to the n^{th} row, respectively. In this manner, the pixel circuits 20 in the first row to the n^{th} row may sequentially enter the reset and initialization stage, and the pixel circuits 20 in the first row to the n^{th} row may also sequentially enter the write and compensation stage. Additionally, for the same row of pixel circuits 20, the reset and initialization stage is before the write and compensation stage. For example, during the display duration of one frame of the display panel 100, the reset and initialization stage t11 of the first row of pixel circuits 20, the write and compensation stage t21 of the first row of pixel circuits 20, the reset and initialization stage t12 of the second row of pixel circuits 20, the write and compensation stage t22 of the second row of pixel circuits 20, . . . , the reset and initialization stage t1n of the n^{th} row of pixel circuits 20, and the write and compensation stage t2n of the n^{th} row of pixel circuits 20 are sequentially performed. After the reset and initialization stage and the write and compensation stage of each row of pixel circuits 20 are completed, each row of pixel circuits 20 enters the light emission stage to cause the pixel circuits 20 in the first row to the n^{th} row to sequentially drive the light-emitting elements 40 electrically connected thereto to emit light, thereby allowing the display panel 100 to present corresponding display images in the forward scan mode.

With reference to FIGS. 3, 4, 6 and 12, when the operating mode of the display panel 100 is the reverse scan mode, the n^{th}-stage shift register unit Gn to the first-stage shift register unit G1 supply the first gate signals S1 to the reset modules 240 and the initialization modules 250 of the pixel circuits 20 in the n^{th} row to the first row and supply the second gate signals S2 to the data write modules 220 and the compensation modules 230 of the pixel circuits 20 in the n^{th} row to the first row, respectively. In this manner, the pixel circuits 20 in the n^{th} row to the first row may sequentially enter the reset and initialization stage, and the pixel circuits 20 in the n^{th} row to the first row may also sequentially enter the write and compensation stage. Additionally, for the same row of pixel circuits 20, the reset and initialization stage is before the write and compensation stage. For example, during the display duration of one frame of the display panel 100, the reset and initialization stage t1n of the n^{th} row of pixel circuits 20, the write and compensation stage t2n of the n^{th} row of pixel circuits 20, . . . , the reset and initialization stage t12 of the second row of pixel circuits 20, the write and compensation stage t22 of the second row of pixel circuits 20, the reset and initialization stage t11 of the first row of pixel circuits 20, and the write and compensation stage t21 of the first row of pixel circuits 20 are sequentially performed. After the reset and initialization stage and the write and compensation stage of each row of pixel circuits 20 are completed, each row of pixel circuits 20 enters the light emission stage to cause the pixel circuits 20 in the n^{th} row to the first row to sequentially drive the light-emitting elements 40 electrically connected thereto to emit light, thereby allowing the display panel 100 to present corresponding display images in the reverse scan mode.

In the above embodiments, by providing the shift register unit in the driver circuit with a first output module, a second output module, a first output terminal and a second output terminal and by setting the first output module to control the first gate signal output from the first output terminal and the second output module to control the second gate signal output from the second output terminal, the effective pulses of the first gate signal and the second gate signal output by the same shift register unit may be sequentially shifted, that is, a shift register unit may output two gate drive signals sequentially shifted, to control the on and off of at least two modules that are not turned on simultaneously in the same pixel circuit without the need to additionally provide corresponding shift register units, thereby reducing the number of shift register units in the driver circuit, reducing the space occupied by the driver circuit, facilitating the implementation of the narrow-bezel design of the display panel and improving the display performance of the display panel. Furthermore, by electrically connecting the first output terminal or the second output terminal of the x^{th}-stage shift register unit to the forward input terminal of the y^{th}-stage shift register unit and electrically connecting the reverse input terminal of the y^{th}-stage shift register unit to the first output terminal or the second output terminal of the k^{th}-stage shift register unit, when the operating mode of the display panel is the forward scan mode, the first-stage shift register unit to the n^{th}-stage shift register unit may sequentially output the effective pulses of the first gate signals and sequentially output the effective pulses of the second gate signals under the control of the signals received by the forward input terminals, the clock signals of the clock terminals and the forward scan control signals of the forward control terminals of stages of shift register units, and when the operating mode of the display panel is the reverse scan mode, the n^{th}-stage shift register unit to the first-stage shift register unit may sequentially output the effective pulses of the first gate signals and sequentially output the effective pulses of the second gate signals under the control of the signals received by the reverse input terminals, the clock signals of the clock terminals and the reverse scan control signals of the reverse control terminals of the stages of shift register units. That is, the first gate signals and the second gate signals output by the stages of shift register units in the driver circuit may cooperate with the forward scan mode and the reverse scan mode of the display panel to enable the driver circuit to obtain both forward and reverse scan functions. Therefore, on the premise of ensuring that the driver circuit has a small size, the driver circuit has the forward and reverse scan functions to meet the scan requirements of the display panel in different modes, thereby broadening the application scenario of the display panel and improving the display effect of the display panel.

It is to be understood that the shift register unit and the manner in which the shift register unit supplies the first gate signal and the second gate signal to the pixel circuit are illustrated above only by way of example. On the premise that the core inventive points in the embodiments of the present disclosure are achieved, the shift register unit and the manner in which the shift register unit supplies the first gate signal and the second gate signal to the pixel circuit are not specifically limited in the embodiments of the present disclosure. To more clearly explain the embodiments of the present disclosure, the shift register unit is illustrated below using typical examples.

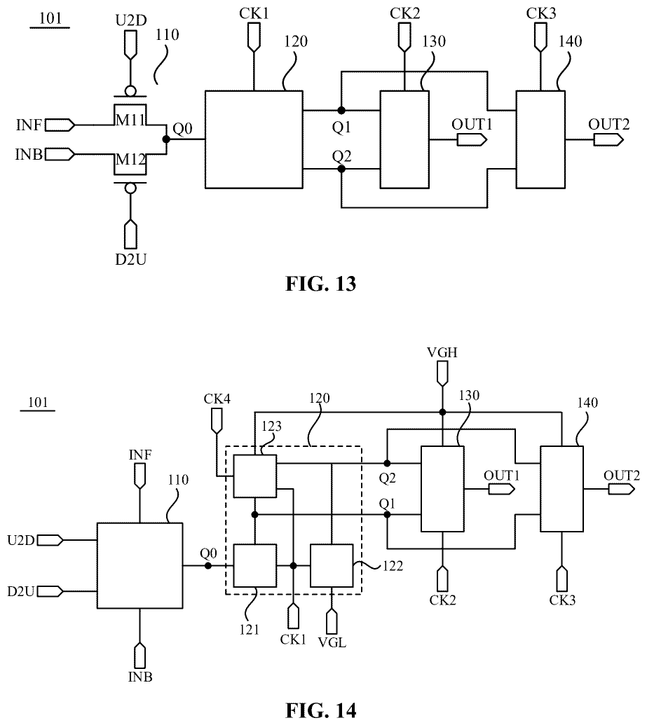

Optionally, FIG. 13 is a structure diagram of another shift register unit according to an embodiment of the present disclosure. As shown in FIG. 13, the scan control module 110 includes a forward scan control transistor M11 and a reverse scan control transistor M12. A gate of the forward scan control transistor M11 is electrically connected to the forward control terminal U2D, a first electrode of the forward scan control transistor M11 is electrically connected to the forward input terminal INF, and a second electrode of the forward scan control transistor M11 is electrically connected to the input node Q0. A gate of the reverse scan control transistor M12 is electrically connected to the reverse control terminal D2U, a first electrode of the reverse scan control transistor M12 is electrically connected to the reverse input terminal INB, and a second electrode of the reverse scan control transistor M12 is electrically connected to the input node Q0.

The forward scan control signal u2d of the forward control terminal U2D may control the forward scan control transistor M11 to be turned on or off. When the forward scan control signal u2d is at an effective level, the forward scan control signal u2d may control the forward scan control transistor M11 to be turned on, and the forward scan control transistor M11 may transmit the forward input signal Vinf of the forward input terminal INF to the input node Q0 so that the signal of the input node Q0 may be consistent with the forward input signal Vinf. The reverse scan control signal d2u of the reverse control terminal D2U may control the reverse scan control transistor M12 to be turned on or off. When the reverse scan control signal d2u is at an effective level, the reverse scan control signal d2d may control the reverse scan control transistor M12 to be turned on, and the reverse scan control transistor M12 may transmit the reverse input signal Vinb of the reverse input terminal INB to the input node Q0 so that the signal of the input node Q0 may be consistent with the reverse input signal Vinb.

In the forward scan mode, the forward scan control signal u2d is at an effective level, and the reverse scan control signal d2u is at an effective level so that the signal of the input node Q0 may be consistent with the forward input signal Vinf in the forward scan mode. In the reverse scan mode, the reverse scan control signal d2u is at an effective level, and the forward scan control signal u2d is at an effective level so that the signal of the input node Q0 in the reverse scan mode may be consistent with the reverse input signal Vinb.

Since the forward input terminal INF of the y^{th}-stage shift register unit Gy is electrically connected to the first input terminal OUT1 or the second output terminal OUT2 of the x^{th}-stage shift register unit Gx and the reverse input terminal INB of the y^{th}-stage shift register unit Gy is electrically connected to the first input terminal OUT1 or the second output terminal OUT2 of the k^{th}-stage shift register unit Gk, the signal of the input node Q0 of the y^{th}-stage shift register unit Gy may be consistent with the first gate signal S1x or the second gate signal S2x output by the x^{th}-stage shift register unit Gx in the forward scan mode, and the signal of the input node Q0 of the y^{th}-stage shift register unit Gy may be consistent with the first gate signal S1k or the second gate signal S2k output by the k^{th}-stage shift register unit Gk in the reverse scan mode. In this manner, in the forward scan mode, the effective pulses of the first gate signals S1 output by the first-stage shift register unit G1 to the n^{th}-stage shift register unit Gn are sequentially shifted and the effective pulses of the second gate signals S2 are also sequentially shifted, and in the reverse scan mode, the effective pulses of the first gate signals S1 output by the n^{th}-stage shift register unit Gn to the first-stage shift register unit G1 are sequentially shifted and the effective pulses of the second gate signals S2 are also sequentially shifted.

Optionally, FIG. 14 is a structure diagram of another shift register unit according to an embodiment of the present disclosure. As shown in FIG. 14, the drive control module 120 includes a first node control sub-module 121, a second node control sub-module 122 and a node mutual control sub-module 123. The shift register unit 101 further includes a fourth clock terminal CK4, a first level terminal VGL and a second level terminal VGH. In the same shift register unit 101, the first node control sub-module 121 is electrically connected to the input node Q0, the first clock terminal CK1 and the first node Q1. The second node control sub-module 122 is electrically connected to the first clock terminal CK1, the first level terminal VGL and the second node Q2. The node mutual control sub-module 123 is electrically connected to the second level terminal VGH, the first node Q1, the second node Q2, the first clock terminal CK1 and the fourth clock terminal CK4. The duration of the effective pulse of a fourth clock signal ck4 received by the fourth clock terminal CK4 does not overlap with the duration of the effective pulse of a first clock signal ck1 received by the first clock terminal CK1.

It is to be understood that the first level terminal VGL may receive a first level signal Vgl, the second level terminal VGH may receive a second level signal Vgh, and the polarities of the first level signal Vgl and the second level signal Vgh may be opposite. Specifically, when the first level signal Vgl is at a low level, the second level signal Vgh is at a high level; or, when the first level signal Vgl is at a high level, the second level signal Vgh may be at a low level.

It is also to be understood that the fourth clock signal ck4 may also include a high level and a low level that change with a certain clock cycle, and the effective level of the fourth clock signal ck4 may be high or low, which may be specifically designed according to actual requirements. The technical solutions of the embodiments of the present disclosure are illustrated using an example in which the effective level of the fourth clock signal ck4 is low. Furthermore, the fourth clock signal ck4 remains at an effective level during the duration of the effective pulse of the fourth clock signal ck4, and the fourth clock signal ck4 remains at an ineffective level during the remaining time periods.

Additionally, since the duration of the effective pulse of the first clock signal ck1 does not overlap with the duration of the effective pulse of the fourth clock signal ck4, the first clock signal ck1 is at an ineffective level when the fourth clock signal ck4 is at an effective level, and the fourth clock signal ck4 is at an ineffective level when the first clock signal ck1 is at an effective level.

With continued reference to FIG. 14, since the first node control sub-module 121 is electrically connected to the input node Q0, the first clock terminal CK1 and the first node Q1, the first node control sub-module 121 may control the signal of the first node Q1 according to the signal of the input node Q0 and the first clock signal ck1 of the first clock terminal CK1. For example, the first node control sub-module 121 may be turned on or off under the control of the first clock signal ck1. When the first clock signal ck1 is at an effective level, the first node control sub-module 121 is controlled to be turned on to enable the signal of the input node Q0 to be transmitted to the first node Q1 so that the signal of the first node Q1 may remain consistent with the signal of the input node Q0. Conversely, when the first clock signal ck1 is at an ineffective level, the first node control sub-module 121 is controlled to be turned off to prevent the signal of the input node Q0 from being transmitted to the first node Q1 so that the signal of the first node Q1 may remain unchanged in the absence of any other signal input.

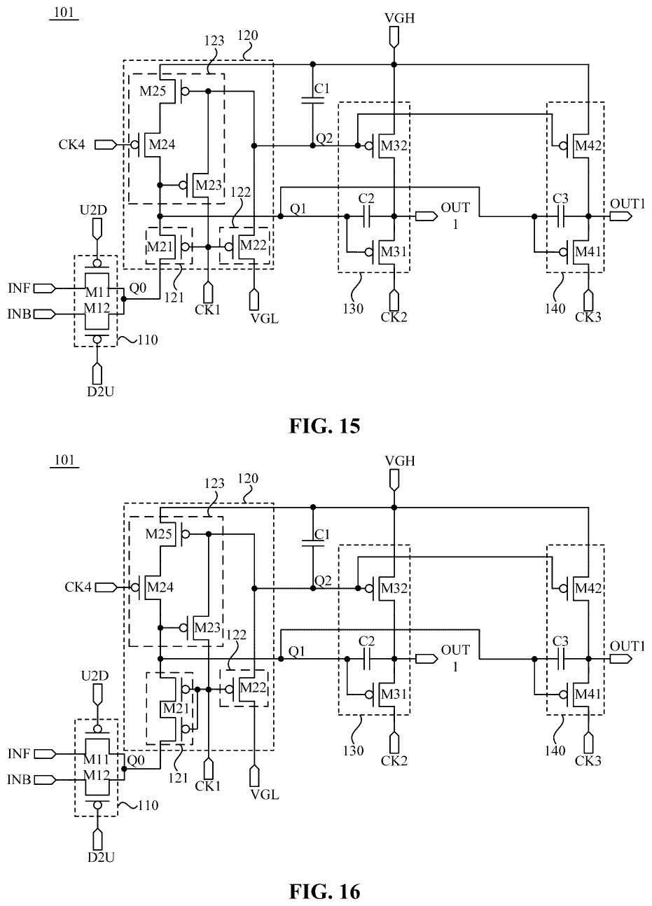

In an optional embodiment, as shown in FIG. 15, the first node control sub-module 121 may include a first node control transistor M21. A gate of the first node control transistor M21 may be electrically connected to the first clock terminal CK1, a first electrode of the first node control transistor M21 may be electrically connected to the input node Q0, and a second electrode of the first node control transistor M21 may be electrically connected to the first node Q1. Therefore, the first node control transistor M21 may be turned on or off under the control of the first clock signal ck1 of the first clock terminal CK1. When the first clock signal ck1 controls the first node control transistor M21 to be turned on, the input node Q0 and the first node Q1 may be controlled to form a conduction path to transmit the signal of the input node Q0 to the first node Q1 so that the signal of the first node Q1 is consistent with the signal of the input node Q0.

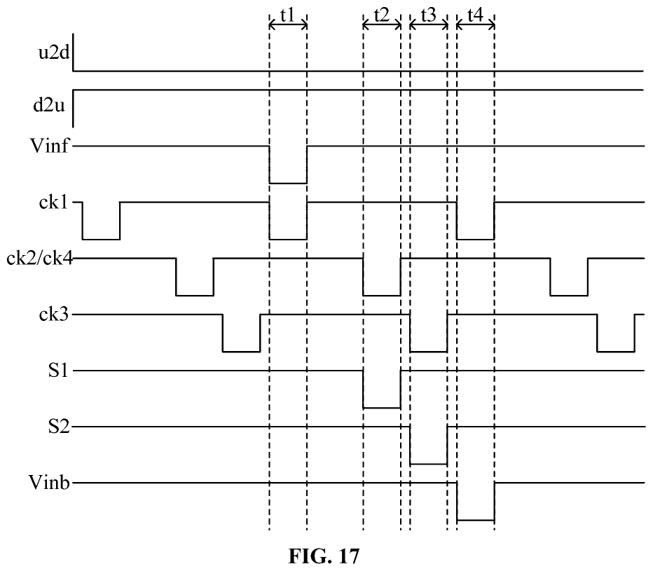

In an optional embodiment, as shown in FIG. 16, the first node control transistor M21 may be a double-gate transistor, and in this case, the first node control transistor M21 may have a relatively low leakage current, thereby ensuring the accuracy of the signal of the first node Q1.

In other optional embodiments, other transistors involved in the shift register unit 101 may also be double-gate transistors so that double-gate transistors in the shift register unit 101 may have a lower leakage current, thereby ensuring the accuracy of the signal of the node in the shift register unit 101. The specific structures of the transistors in the shift register unit 101 may be specifically designed according to actual requirements and are not specifically limited in the embodiments of the present disclosure. For ease of description, unless special limitations are made, the technical solutions in the embodiments of the present disclosure are illustrated using an example in which all the transistors in the in the shift register unit are single-gate transistors in the embodiments of the present disclosure.

With continued reference to FIG. 14, since the second node control sub-module 122 is electrically connected to the first clock terminal CK1, the first level terminal VGL and the second node Q2, the second node control sub-module 122 may control the signal of the second node Q2 according to the first clock signal ck1 of the first clock terminal CK1 and the first level signal Vgl of the first level terminal VGL. For example, the second node control sub-module 122 may be turned on or off under the control of the first clock signal ck1. When the first clock signal ck1 is at an effective level, the second node control sub-module 122 is controlled to be turned on to enable the first level signal Vgl to be transmitted to the second node Q2 so that the signal of the second node Q2 can remain consistent with the first level signal Vgl. Conversely, when the first clock signal ck1 is at an ineffective level, the second node control sub-module 122 is controlled to be turned off to prevent the first level signal Vgl from being transmitted to the second node Q2 so that the signal of the second node Q2 may remain unchanged in the absence of any other signal input.

In an optional embodiment, as shown in FIG. 15, the second node control sub-module 122 may include a second node control transistor M22. A gate of the second node control transistor M22 may be electrically connected to the first clock terminal CK1, a first electrode of the second node control transistor M22 may be electrically connected to the first level terminal VGL, and a second electrode of the second node control transistor M22 may be electrically connected to the second node Q2. Therefore, the second node control transistor M22 may be turned on or off under the control of the first clock signal ck1 of the first clock terminal CK1. When the first clock signal ck1 controls the second node control transistor M22 to be turned on, the first level signal Vgl may be controlled to be transmitted to the second node Q2 so that the signal of the second node Q2 remains consistent with the first level signal Vgl.

With continued reference to FIG. 14, since the node mutual control sub-module 123 is electrically connected to the second level terminal VGH, the first node Q1, the second node Q2, the first clock terminal CK1 and the fourth clock terminal CK4, the node mutual control sub-module 123 may control the signal of the second node Q2 according to the signal of the first node Q1 and the first clock signal ck1 of the first clock terminal CK1 and control the signal of the first node Q1 according to the second level signal Vgh of the second level terminal VGH, the signal of the second node Q2 and the fourth clock signal ck4 of the fourth clock terminal CK4 so that the signals of the first node Q1 and the second node Q2 clamp each other to ensure that at least part of the duration of the effective level of the signal of the first node Q1 does not overlap with the duration of the effective level of the signal of the second node Q2.

In an optional embodiment, as shown in FIG. 15, the node mutual control sub-module 123 may include a first node mutual control transistor M23, a second node mutual control transistor M24 and a third node mutual control transistor M25. A gate of the first node mutual control transistor M23 may be electrically connected to the first node Q1, a first electrode of the first node mutual control transistor M23 is electrically connected to the first clock terminal CK1, and a second electrode of the first node mutual control transistor M23 is electrically connected to the second node Q2. A gate of the second node mutual control transistor M24 may be electrically connected to the second node Q2, a first electrode of the second node mutual control transistor M24 is electrically connected to the second level terminal VGH, and a second electrode of the second node mutual control transistor M24 is electrically connected to a first electrode of the third node mutual control transistor M25. A gate of the third node mutual control transistor M25 may be electrically connected to the fourth clock terminal CK4, and a second electrode of the third node mutual control transistor M25 may be electrically connected to the first node Q1.

During the duration when the signal of the first node Q1 is at an effective level, the first node mutual control transistor M23 may be controlled to be in an on state to enable the first node mutual control transistor to transmit the first clock signal ck1 to the second node Q2 so that the signal of the second node Q2 is consistent with the first clock signal ck1. That is, the signal of the second node Q2 is at an effective level when the first clock signal ck1 is at an effective level, and the signal of the second node Q2 also jumps to an ineffective level when the first clock signal ck1 is at an ineffective level. Correspondingly, when the signal of the second node Q2 is at an effective level, the third node mutual control transistor M25 is in an on state to enable the second level signal Vgh to be transmitted to the first electrode of the second node mutual control transistor M24. In this case, if the fourth clock signal ck4 is at an effective level, the second node mutual control transistor M24 is in an on state to enable the second level signal Vgh at the first electrode of the second node mutual control transistor M24 to be transmitted to the first node Q1 so that the signal of the first node Q1 is consistent with the second level signal Vgh and is at an ineffective level. Therefore, during at least part of the duration when the signal of the first node Q1 is at an effective level, the signal of the second node Q2 may remain at an ineffective level, and during at least part of the duration when the signal of the second node Q2 is at an effective level, the signal of the first node Q1 may remain at an ineffective level so that the signals of the first node Q1 and the second node Q2 may be mutually controlled, thereby ensuring that the first output module 130 electrically connected to the first node Q1 and the second node Q2 may stably output the first gate signal S1 and the second output module 140 may stably output the second gate signal S2.

It is to be understood that since the node mutual control sub-module 123 may control the signal of the second node Q2 according to the first clock signal ck1 and the signal of the first node Q1 and control the signal of the first node Q1 according to the second level signal Vgh, the fourth clock signal ck4 and the signal of the second node Q2, in order to ensure that the signals of the first node Q1 and the second node Q2 can be mutually controlled and do not interfere with each other, the duration of the effective level of the first clock signal ck1 can be set to not overlap with the duration of the effective level of the fourth clock signal ck4. In this manner, when the first clock signal ck1 is at an effective level, and the fourth clock signal ck4 is at an ineffective level so that, when the first node mutual control transistor M23 transmits the effective level of the first clock signal ck1 to the second node Q2, the second node mutual control transistor M24 may be in an off state, thereby preventing the second level signal Vgh from being transmitted to the first node Q1 and affecting the accuracy of the signal of the first node Q1. Accordingly, when the fourth clock signal ck4 is at an effective level, the first clock signal ck1 is at an ineffective level, thereby preventing the signal of the second node Q2 from being affected during the duration when the second level signal Vgh is transmitted to the first node Q1 through the third node mutual control transistor M25 and the second node mutual control transistor M24.

Furthermore, in order to ensure that the effective pulses of the first gate signals S1 output by various stages of shift register units 101 are sequentially shifted and the effective pulses of the second gate signals S2 output by various stages of shift register units 101 are sequentially shifted, when the first gate signal S1 or the second gate signal of a shift register unit 101 cascaded with the current stage shift register unit 101 is at an effective level, the signal of the input node Q0 is at an effective level, and the first clock signal ck1 is at an effective level so that, when the first clock signal ck1 controls the first node control sub-module 121 to be in an on state, the signal of the input node Q0 may be transmitted to the first node Q1 to charge the first node Q1. Additionally, the second clock signal ck2 and the third clock signal ck3 may remain at ineffective levels so that both the first gate signal S1 and the second gate signal S2 may remain at ineffective levels. After the charging of the first node Q1 is completed, the first clock signal ck1 jumps to an ineffective level, and in this case, the second clock signal ck2 and the third clock signal ck3 may be sequentially controlled to jump to ineffective levels so that the effective pulses of the first gate signal S1 and the second gate signal S2 may be sequentially output. Therefore, the durations of the effective pulses of the first clock signal ck1, the second clock signal ck2 and the third clock signal ck3 do not overlap. For example, the durations of the effective pulses of the first clock signal ck1, the second clock signal ck2 and the third clock signal ck3 are sequentially shifted within one clock cycle.

Correspondingly, since the duration of the effective pulse of the fourth clock signal ck4 does not overlap with the duration of the effective pulse of the first clock signal ck1 and the duration of the effective pulse of the second clock signal ck2 and the duration of the effective pulse of the third clock signal ck3 also do not overlap the duration of the effective pulse of the first clock signal ck1, in an optional embodiment, when the second clock terminal CK2 is configured to receive the second clock signal ck2 and the third clock terminal CK3 is configured to receive the third clock signal ck3, the fourth clock signal ck4 may be the same as either the second clock signal ck2 or the third clock signal ck3, and the fourth clock terminal CK4 may be reused as either the second clock terminal CK2 or the third clock terminal CK3. Therefore, the number of clock terminals provided in the shift register unit 101 can be reduced, and the number of clock signals supplied to the same shift register unit 101 can be reduced, thereby simplifying the structure of the shift register unit, reducing the number of signal transmission lines for transmitting the clock signals and facilitating the implementation of the narrow-bezel design of the display panel.

It is to be noted that the structure of the drive control module 120 is illustrated above only by way of example. On the premise that the drive control module 120 may accurately control the signals of the first node Q1 and the second node Q2, the specific structure of the drive control module 120 is not specifically limited in the embodiments of the present disclosure.

Optionally, as shown in FIG. 15, the first output module 130 may include a first output transistor M31 and a second output transistor M32. In this case, the shift register unit 101 may further include a second level terminal VGH. In the same shift register unit 101, a gate of the first output transistor M31 is electrically connected to the first node Q1, a first electrode of the first output transistor M31 is electrically connected to the second clock terminal CK2, and a second electrode of the first output transistor M31 is electrically connected to the first output terminal OUT1. A gate of the second output transistor M32 is electrically connected to the second node Q2, a first electrode of the second output transistor M32 is electrically connected to the second level terminal VGH, and a second electrode of the second output transistor M32 is electrically connected to the first output terminal OUT1.

The signal of the first node Q1 may control the first output transistor M31 to be turned on or off. When the signal of the first node Q1 is at an effective level, the first output transistor M31 may be controlled to be turned on to enable the second clock signal ck2 of the second clock terminal CK2 to be transmitted to the first output terminal OUT1 so that the first gate signal S1 output from the first output terminal OUT1 is consistent with the second clock signal ck2. The signal of the second node Q2 may control the second output transistor M32 to be turned on or off. When the signal of the second node Q2 is at an effective level, the second output transistor M32 may be controlled to be turned on to enable the second level signal Vgh of the second level terminal VGH to be transmitted to the first output terminal OUT1 so that the first gate signal S1 output from the first output terminal OUT1 is consistent with the second level signal Vgh. Therefore, by controlling the signals of the first node Q1 and the second node Q2, the turn-on durations of the first output transistor M31 and the second output transistor M32 can be controlled, thereby controlling the duration of the effective pulse of the first gate signal S1 output from the first output terminal OUT1.

Optionally, with continued reference to FIG. 15, the second output module 140 includes a third output transistor M41 and a fourth output transistor M42. In this case, the shift register unit 101 further includes a second level terminal VGH. In the same shift register unit 101, a gate of the third output transistor M41 is electrically connected to the first node Q1, a first electrode of the third output transistor M41 is electrically connected to the third clock terminal CK3, and a second electrode of the third output transistor M41 is electrically connected to the second output terminal OUT2. A gate of the fourth output transistor M42 is electrically connected to the second node Q2, a first electrode of the fourth output transistor M42 is electrically connected to the second level terminal VGH, and a second electrode of the fourth output transistor M42 is electrically connected to the second output terminal OUT2.

The signal of the first node Q1 may control the third output transistor M41 to be turned on or off. When the signal of the first node Q1 is at an effective level, the third output transistor M41 may be controlled to be turned on to enable the third clock signal ck3 of the third clock terminal CK3 to be transmitted to the second output terminal OUT2 so that the second gate signal S2 output from the second output terminal OUT2 is consistent with the third clock signal ck3. The signal of the second node Q2 may control the fourth output transistor M42 to be turned on or off. When the signal of the second node Q2 is at an effective level, the fourth output transistor M42 may be controlled to be turned on to enable the second level signal Vgh of the second level terminal VGH to be transmitted to the second output terminal OUT2 so that the second gate signal S2 output from the second output terminal OUT2 is consistent with the second level signal Vgh. Therefore, by controlling the signals of the first node Q1 and the second node Q2, the turn-on durations of the third output transistor M41 and the fourth output transistor M42 can be controlled, thereby controlling the duration of the effective pulse of the second gate signal S2 output from the second output terminal OUT2.

To more clearly explain the technical solutions of the embodiments of the present disclosure, the operating process of the shift register unit is illustrated below using typical examples.

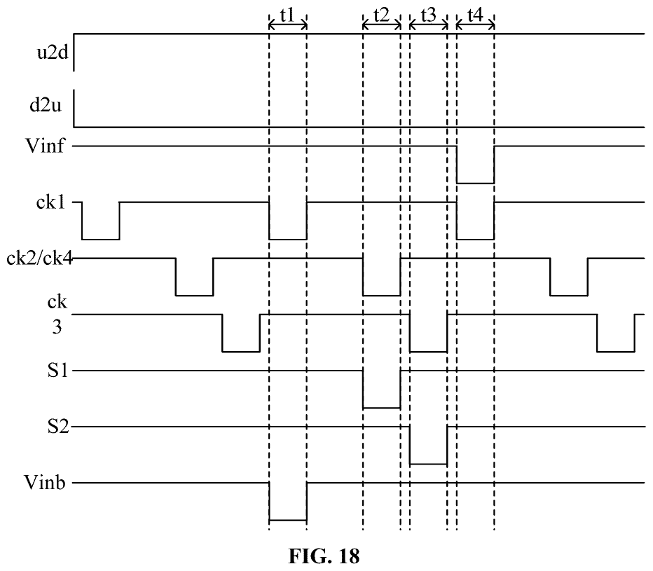

FIG. 17 is a drive timing diagram of a shift register unit in the forward scan mode according to an embodiment of the present disclosure, and FIG. 18 is a drive timing diagram of a shift register unit in the reverse scan mode according to an embodiment of the present disclosure. With reference to FIGS. 15, 17 and 18, the drive cycle of the shift register unit 101 includes a stage t1, a stage t2, a stage t3 and a stage t4.

With reference to FIGS. 15 and 17, in the forward scan mode, the forward scan control signal u2d received by the forward control terminal U2D is at an effective level, and the reverse scan control signal d2u received by the reverse control terminal D2U is at an ineffective level. In this case, the forward scan control transistor M11 is turned on, and the reverse scan control transistor M12 is turned off so that the signal of the input node Q0 is consistent with the forward input signal Vinf of the forward input terminal INF.

Before the stage t1, the forward input signal Vinf is at an ineffective level so that the signal of the input node Q0 is at an ineffective level. When the first clock signal ck1 is at an effective level, the first node control transistor M21 and the second node control transistor M22 are controlled to be turned on so that the signal of the first node Q1 is consistent with the signal of the input node Q0 and the signal of the second node Q2 is consistent with the first level signal Vgl, that is, the signal of the first node Q1 is at an ineffective level and the signal of the second node Q2 is at an effective level. Both the first output transistor M31 and the third output transistor M41 are in off states, both the second output transistor M32 and the fourth output transistor M42 are in on states, and both the first gate signal S1 output from the first output terminal OUT1 and the second gate signal S2 output from the second output terminal OUT1 are consistent with the second level signal Vgh, that is, both the first gate signal S1 and the second gate signal S2 are at ineffective levels.

In the stage t1, the forward input signal Vinf is at an effective level, the first clock signal ck1 is at an effective level, the second clock signal ck2, the third clock signal ck3 and the fourth clock signal ck2 are at ineffective levels, and the signal of the input node Q0 is at an effective level. The effective level of the input node Q0 is transmitted to the first node Q1, and the signal of the first node Q1 then jumps to an effective level. The first output transistor M31 and the third output transistor M41 are turned on, the first gate signal S1 is consistent with the second clock signal ck2, and the second gate signal S2 is consistent with the third clock signal ck3 so that both the first gate signal S1 and the second gate signal S2 remain at ineffective levels. Meanwhile, the first level signal Vgl is transmitted to the second node Q2. Since the first node Q1 is at an effective level, the first node mutual control transistor M23 is turned on, the effective level of the first clock signal ck1 is transmitted to the second node Q2, and the second node Q2 is at an effective level. The second output transistor M32 and the fourth output transistor M42 are in on states, and the second level signal Vgh of the second level terminal VGH is transmitted to the first output terminal OUT1 and the second output terminal OUT2 so that the first output terminal OUT1 outputs the ineffective level of the first gate signal S1 and the second output terminal OUT2 outputs the ineffective level of the second gate signal S2.

In the stage t2, the forward input signal Vinf is at an ineffective level, the first clock signal ck1 and the third clock signal ck3 are at ineffective levels, and the second clock signal ck2 and the fourth clock signal ck4 are at effective levels. Both the first node control transistor M21 and the second node control transistor M22 are in off states, the ineffective level of the input node Q0 cannot be transmitted to the first node Q1, the first level signal Vgl cannot be transmitted to the second node Q2, and the signal of the first node Q1 may remain at an effective level. Meanwhile, the signal of the first node Q1 controls the first node mutual control transistor M23 to be turned on, the ineffective level of the first clock signal ck1 is then transmitted to the second node Q2, the signal of the second node Q2 jumps to an ineffective level, and the third node mutual control transistor M25 is in an off state. In this case, even if the fourth clock signal ck4 controls the second node mutual control transistor M24 to be turned on, the second level signal Vgh cannot be transmitted to the first node Q1 so that the first node Q1 may remain at an effective level. The signal of the first node Q1 may control the first output transistor M31 and the third output transistor M41 to be turned on, the signal of the second node Q2 may control the second output transistor M32 and the fourth output transistor M42 to be turned off so that the first gate signal S1 output from the first output terminal OUT1 is consistent with the second clock signal ck2 and the second gate signal S2 output from the second output terminal OUT2 is consistent with the third clock signal ck3, that is, the first gate signal S1 is at an effective level and the second gate signal S2 is at an ineffective level.

In the stage t3, the forward input signal Vinf remains at an ineffective level, the first clock signal ck1, the second clock signal ck2 and the fourth clock signal ck4 are at ineffective levels, and the third clock signal ck3 is at an effective level. On the premise that no any new signal is written, the signal of the first node Q1 remains at an effective level, the signal of the second node Q2 remains at an ineffective level, the first output transistor M31 and the third output transistor M41 continuously remain in on states, the second output transistor M32 and the fourth output transistor M42 continuously remain in off states, the first gate signal S1 jumps to an ineffective level, and the second gate signal S2 jumps to an effective level.

In the stage t4, the forward input signal Vinf remains at an ineffective level, the first clock signal ck1 is at an effective level, and the second clock signal ck2, the third clock signal ck3 and the fourth clock signal ck2 are at ineffective levels. The first node control transistor M21 and the second node control transistor M22 are turned on again, the ineffective level of the input node Q0 is transmitted to the first node Q1, the first level signal Vgl is transmitted to the second node Q2, the signal of the first node Q1 jumps to an ineffective level, and the signal of the second node Q2 jumps to an effective level. The first output transistor M31 and the third output transistor M41 are turned off, the second output transistor M32 and the fourth output transistor M42 are turned on, and the second level signal Vgh is transmitted to the first output terminal OUT1 and the second output terminal OUT2 so that the first output terminal OUT1 outputs the ineffective level of the first gate signal S1 and the second output terminal OUT2 outputs the ineffective level of the second gate signal S2.

After the t4 stage, the forward input signal Vinf continuously remains at an ineffective level so that the signal at an ineffective level may be continuously supplemented to the first node Q1 under the control of the first clock signal ck1 and the fourth clock signal ck4, and the signal of the second node Q2 jumps between the effective level and the ineffective level until the next drive cycle is entered.

Therefore, in the forward scan mode, the shift register unit 101 may control the effective pulses of the first gate signal S1 output from the first output terminal OUT1 and the second gate signal S2 output from the second output terminal OUT2 to be sequentially shifted based on the forward input signal Vinf of the forward input terminal INF, the first clock signal ck1, the second clock signal ck2, the third clock signal ck3 and the fourth clock signal ck4 to ensure that the pixel circuits electrically connected to the shift register unit 101 can operate normally in the forward scan mode, thereby allowing the display panel to accurately display images.

Correspondingly, with reference to FIGS. 15 and 18, in the reverse scan mode, the forward scan control signal u2d received by the forward control terminal U2D is at an ineffective level, and the reverse scan control signal d2u received by the reverse control terminal D2U is at an effective level. In this case, the reverse scan control transistor M12 is turned on, and the forward scan control transistor M11 is turned off so that the signal of the input node Q0 is consistent with the reverse input signal Vinb of the reverse input terminal INB.

The driving process of the shift register unit 101 in the reverse scan mode is similar to the driving process of the shift register unit 101 in the forward scan mode. For specifics, reference may be made to the description of the driving process of the shift register unit 101 in the forward scan mode, and the details are not repeated here.

It is to be understood that, in the reverse scan mode, the shift register unit 101 may control the effective pulses of the first gate signal S1 output from the first output terminal OUT1 and the second gate signal S2 output from the second output terminal OUT2 to be sequentially shifted based on the reverse input signal Vinb of the reverse input terminal INB, the first clock signal ck1, the second clock signal ck2, the third clock signal ck3 and the fourth clock signal ck4 to ensure that the pixel circuits electrically connected to the shift register unit 101 can operate normally in the reverse scan mode, thereby allowing the display panel to accurately display images.

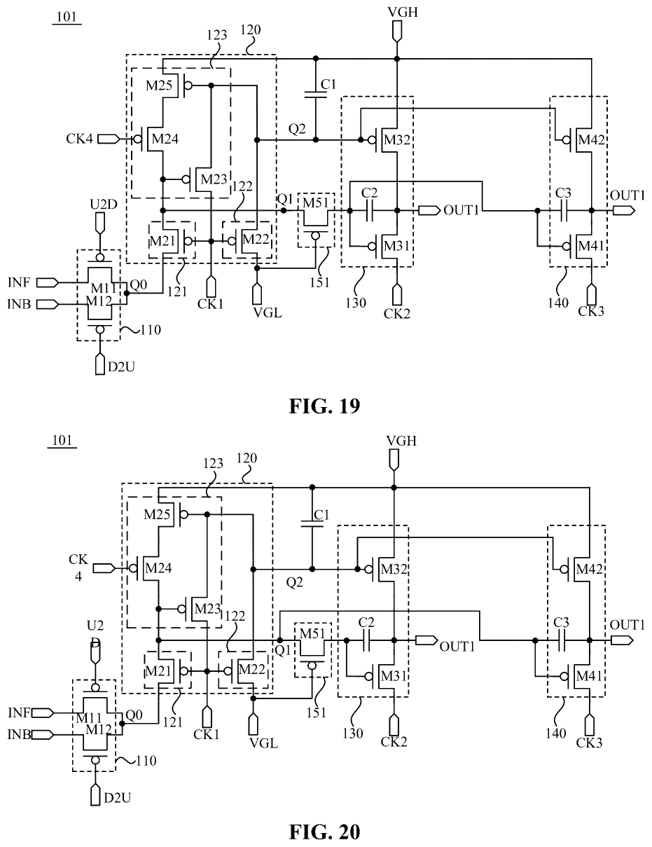

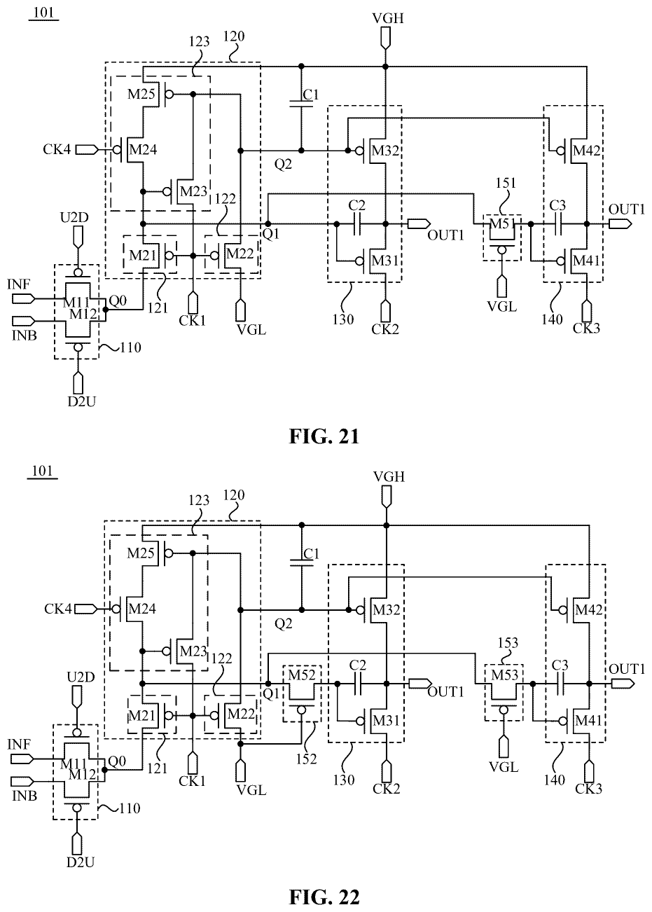

On the basis of the above embodiments, optionally, FIG. 19 is a structure diagram of another shift register unit according to an embodiment of the present disclosure, FIG. 20 is a structure diagram of another shift register unit according to an embodiment of the present disclosure, and FIG. 21 is a structure diagram of another shift register unit according to an embodiment of the present disclosure. With reference to FIGS. 19 to 21, the shift register unit 101 further includes a first voltage regulation module 151. In the same shift register unit 101, the first output module 130 and/or the second output module 140 are electrically connected to the first node Q1 through the first voltage regulation module 151.

When the first output module 130 includes the first output transistor M31 and the second output transistor M32 and the second output module 140 includes the third output transistor M41 and the fourth output transistor M42, the first output module 130 and/or the second output module 140 being electrically connected to the first node Q1 through the first voltage regulation module 151 may be understood as the gate of the first output transistor M31 and/or the gate of the third output transistor M41 being electrically connected to the first node Q1 through the first voltage regulation module 151. In this case, the node to which the gate of the first output transistor M31 and/or the gate of the third output transistor M41 are electrically connected and the first node Q1 are different nodes so that the first voltage regulation module 151 may isolate the gate of the first output transistor M31 and/or the gate of the third output transistor M41 from the first node Q1 to ensure that the signal of the first node Q1 and signals at the gate of the first output transistor M31 and/or the gate of the third output transistor M41 can be relatively stable. In this manner, the signal fluctuations at the first node Q1 are prevented from affecting the signal at the gate of the first output transistor M31 and/or the gate of the third output transistor M41 or the signal fluctuations at the gate of the first output transistor M31 and/or the gate of the third output transistor M41 are prevented from affecting the signal of the first node Q1, and the accuracy of the first gate signal S1 output from the first output terminal OUT1 and/or the second gate signal S2 output from the second output terminal OUT2 may be ensured, thereby enhancing the operational stability of the shift register unit 101 and improving the display performance of the display panel.

In an optional embodiment, the first voltage regulation module 151 may include a first voltage regulation transistor M51. A first electrode of the first voltage regulation transistor M51 may be electrically connected to the first node Q1, and a second electrode of the first voltage regulation transistor M51 may be electrically connected to the first output module 130 and/or the second output module 140. For example, the second electrode of the first voltage regulation transistor M51 may be electrically connected to the gate of the first output transistor M31 and/or the gate of the third output transistor M41, and the gate of the first voltage regulation transistor M51 may receive a first voltage regulation control signal. When both the signal of the first node Q1 and the signal at the gate of the first output transistor M31 and/or the gate of the third output transistor M41 are within normal signal ranges, the first voltage regulation control signal may control the first voltage regulation transistor M51 to be in an on state.

The first voltage regulation transistor M51 may be an n-type transistor or a p-type transistor, which may be specifically designed according to actual requirements and is not specifically limited in the embodiments of the present disclosure. Taking the first voltage regulation transistor M51 as a p-type transistor as an example, the first voltage regulation control signal may be a low-level signal, and in this case, the first voltage regulation control signal may be used as the first level signal Vg1 of the first level terminal VGL, thereby reducing the number of signals supplied to the shift register unit 101 and lowering the driving cost of the shift register unit 101.

It is to be understood that the first output module 130 and/or the second output module 140 are electrically connected to the first node Q1 through the first voltage regulation module 151. That is, as shown in FIG. 19, both the first output module 130 and the second output module 140 are indirectly electrically connected to the first node Q1 through the first voltage regulation module 151; as shown in FIG. 20, the first output module 130 is indirectly electrically connected to the first node Q1 through the first voltage regulation module 151, and the second output module 140 may be directly electrically connected to the first node Q1; or, as shown in FIG. 21, the second output module 140 is indirectly electrically connected to the first node Q1 through the first voltage regulation module 151, and the first output module 130 is directly electrically connected to the first node Q1. The connection mode among the first output module 130, the second output module 140 and the first node Q1 may be specifically designed according to actual requirements and is not specifically limited in the embodiments of the present disclosure.

In another optional embodiment, FIG. 22 is a structure diagram of another shift register unit according to an embodiment of the present disclosure. As shown in FIG. 22, the shift register unit 101 may further include a second voltage regulation module 152 and a third voltage regulation module 153. In the same shift register unit 101, the first output module 130 is electrically connected to the first node Q1 through the second voltage regulation module 152, and the second output module 140 is electrically connected to the first node Q1 through the third voltage regulation module 153. In this case, the first output module 130 and the second output module 140 are indirectly electrically connected to the first node Q1 through different voltage regulation modules (that is, the second voltage regulation module 152 and the third voltage regulation module 153), respectively.

By setting the second voltage regulation module 152 between the first output module 130 and the first node Q1, the second voltage regulation module 152 can ensure that the signal of the first node Q1 and the signal at the node to which the first output module 130 is directly electrically connected remain relatively stable so that the first output module 130 can accurately control the first output terminal OUT1 to output the first gate signal S1. Meanwhile, by setting the third voltage regulation module 153 between the second output module 140 and the first node Q1, the third voltage regulation module 153 can ensure that the signal of the first node Q1 and the signal at the node to which the second output module 140 is directly electrically connected remain relatively stable so that the second output module 140 can accurately control the second output terminal OUT2 to output the second gate signal S2. Therefore, when the first gate signal S1 and the second gate signal S2 control the operating process of the pixel circuit in the display panel, the corresponding signals can be accurately written to the pixel circuit to enable the pixel circuit to control the light-emitting element to accurately emit light, thereby improving the display performance of the display panel.

In an optional embodiment, the second voltage regulation module 152 may include a second voltage regulation transistor M52. A gate of the second voltage regulation transistor M52 may receive a second voltage regulation control signal, a first electrode of the second voltage regulation transistor M52 may be electrically connected to the first node Q1, and a second electrode of the first voltage regulation transistor M52 may be electrically connected to the first output module 130. When both the signal of the first node Q1 and the signal at the node to which the first output module 130 is directly electrically connected are within normal signal ranges, the second voltage regulation control signal may control the second voltage regulation transistor M52 to be in an on state.

The third voltage regulation module 153 may include a third voltage regulation transistor M53. A gate of the third voltage regulation transistor M53 may receive a third voltage regulation control signal, a first electrode of the third voltage regulation transistor M53 may be electrically connected to the first node Q1, and a second electrode of the third voltage regulation transistor M53 may be electrically connected to the second output module 140. When both the signal of the first node Q1 and the signal at the node to which the second output module 140 is directly electrically connected are within normal signal ranges, the third voltage regulation control signal may control the third voltage regulation transistor M53 to be in an on state.

The channel types of the second voltage regulation transistor M52 and the third voltage regulation transistor M53 may be the same or different, that is, both of them may be n-type transistors or p-type transistors or one of the two may be a p-type transistor while the other may be an n-type transistor, may be specifically designed according to actual requirements and is not specifically limited in the embodiments of the present disclosure. Taking both the second voltage regulation transistor M52 and the third voltage regulation transistor M53 as p-type transistors as an example, both the second voltage regulation control signal and the third voltage regulation control signal may be low-level signals, and in this case, both the second voltage regulation control signal and the third voltage regulation control signal may be used as the first level signal Vg1 of the first level terminal VGL, thereby reducing the number of signals supplied to the shift register unit 101 and lowering the driving cost of the shift register unit 101.

On the basis of the above embodiments, optionally, with reference to any one of FIGS. 19 to 22, the shift register unit 101 may further include a first capacitor C1. A first plate of the first capacitor C1 may receive a fixed level signal, and the fixed level signal may be reused as, for example, the second level signal Vgh of the second level terminal VGH. A second plate of the first capacitor C1 may be electrically connected to the second node Q2 so that the first capacitor C1 may store the signal of the second node Q2. In the absence of any other signal input, the signal of the second node Q2 may be maintained as the signal written in the previous stage to ensure the stability of the signal of the second node Q2, thereby improving the control accuracy of the first output module 130 and the second output module 140 and further enhancing the accuracy of the first gate signal S1 output from the first output terminal OUT1 and the second gate signal S2 output from the second output terminal OUT2.

Optionally, with continued reference to any one of FIGS. 19 to 22, the shift register unit 101 may further include a second capacitor C2 and a third capacitor C3. The second capacitor C2 is electrically connected to the first output terminal OUT1 and the gate of the first output transistor M31, and the third capacitor C3 is electrically connected to the second output terminal OUT2 and the gate of the third output transistor M41. When the first gate signal S1 of the first output terminal OUT1 changes, the second capacitor C2 may couple the change amount of the first gate signal S1 to the gate of the first output transistor M31 to pull down or raise the voltage of the signal at the gate of the first output transistor M31. In this manner, the signal at the gate of the first output transistor M31 may have a higher driving capability to drive the first output transistor M31 to be accurately turned on or off. Similar, the third capacitor C3 may couple the change amount of the second gate signal S2 of the second output terminal OUT2 to the gate of the third output transistor M41, and in this manner, the signal at the gate of the third output transistor M41 may have a higher driving capability to drive the third output transistor M41 to be accurately turned on or off.

It is to be understood that the structure of the shift register unit 101 is illustrated above only by way of example. On the premise that the core inventive points in the embodiments of the present disclosure are achieved, the structure of the shift register unit 101 is not specifically limited here. For ease of description, unless special limitations are made, the technical solutions in the embodiments of the present disclosure are illustrated above using the structure of the shift register unit shown in FIG. 22 as an example in the embodiments of the present disclosure.

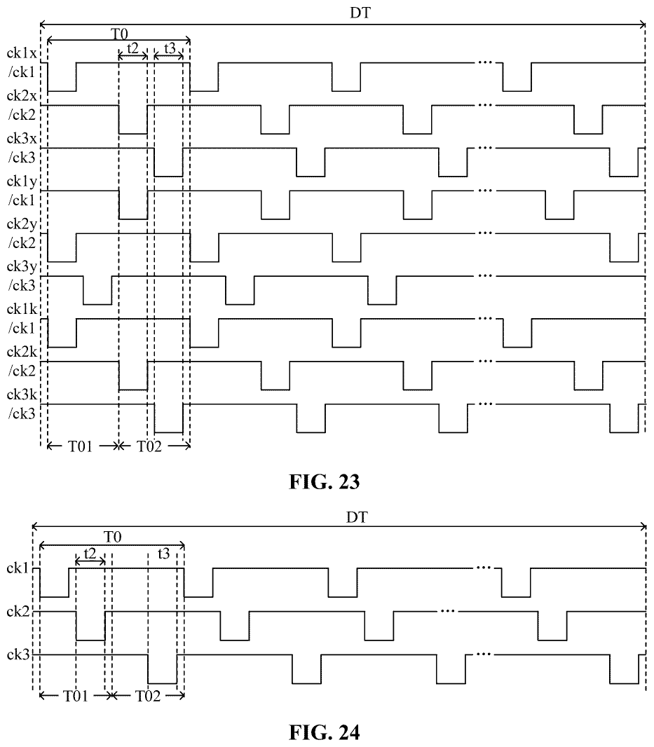

In an optional embodiment, FIG. 23 is a drive timing diagram of another shift register unit according to an embodiment of the present disclosure. With reference to FIGS. 22 and 23, the display duration DT of one frame of the display panel includes multiple clock cycles T0. Within one clock cycle T0, in the same shift register unit 101, the effective pulse of the second clock signal ck2 of the second clock terminal CK2 and the effective pulse of the third clock signal ck3 of the third clock terminal CK3 are sequentially shifted.

The display duration DT of one frame of the display panel may be understood as the time required for the effective pulses of the first gate signals and the second gate signals sequentially output by the stages of shift register units in the driver circuit. In other words, the display duration DT of one frame of the display panel may be equivalent to the time between the start times of two adjacent effective pulses of the first gate signal S1 output by the first-stage shift register unit in the forward scan mode or the time between the start times of two adjacent effective pulses of the first gate signal S1 output by the n^{th}-stage shift register unit in the reverse scan mode.

Correspondingly, the clock cycle may be understood as the time between the start times of two adjacent effective pulses of any clock signal, for example, the time T0 between the start times of two adjacent effective pulses of the first clock signal ck1. For the same shift register unit, each of the first clock signal ck1, the second clock signal ck2, the third clock signal ck3 and the fourth clock signal ck4 includes at least one effective pulse within one clock cycle. Meanwhile, since the display duration DT of one frame includes multiple clock cycles, each of the first clock signal ck1, the second clock signal ck2, the third clock signal ck3 and the fourth clock signal ck4 may include multiple effective pulses within the display duration DT of one frame.

Furthermore, the effective pulse of the second clock signal ck2 and the effective pulse of the third clock signal ck3 being sequentially shifted within one clock cycle T0 may be understood as the duration of the effective pulse of the second clock signal ck2 being before the duration of the effective pulse of the third clock signal ck3. In an optional embodiment, within one clock cycle T0, the time between the end time of the effective pulse of the second clock signal ck2 and the start time of the effective pulse of the third clock signal ck3 may be p*H, where H may be the vibration cycle of the crystal oscillator in the driver chip that supplies the clock signal to the shift register unit 101, that is, H may be the unit duration of the clock signal, and p may be a positive integer. In this manner, the interval time between the effective pulse of the first gate signal S1 of the first output terminal OUT1 and the effective pulse of the second gate signal S2 of the second output terminal OUT2 may be p*H.

Specifically, since both the first output module 130 and the second output module 140 are electrically connected to the first node Q1 and the second node Q2, the first output module 130 and the second output module 140 may control the first gate signal S1 output from the first output terminal OUT1 and the second gate signal S2 output from the second output terminal OUT2 respectively according to the signal of the first node Q1 and the signal of the second node Q2. In an optional embodiment, when the first node Q1 is at an effective level, the first output module 130 may transmit the second clock signal ck2 of the second clock terminal CK2 to the first output terminal OUT1, and the second output module 140 may transmit the third clock signal ck3 of the third clock terminal CK3 to the second output terminal OUT2 so that the first gate signal S1 output from the first output terminal OUT1 may be consistent with the second clock signal ck2 and the second gate signal S2 output from the second output terminal OUT2 may be consistent with the third clock signal ck3. Therefore, within one clock cycle T0, by setting the effective pulse of the second clock signal ck2 of the second clock terminal CK2 and the effective pulse of the third clock signal ck3 of the third clock terminal CK3 in the same shift register unit 101 to be sequentially shifted, the effective pulses of the first gate signal S1 and the second gate signal S2 output by the same shift register unit 101 may be sequentially shifted so that different modules in the pixel circuit may be controlled by using the first gate signal S1 and the second gate signal S2 output by the same shift register unit 101, thereby reducing the number of shift register units provided in the driver circuit, reducing the size of the driver circuit, and facilitating the implementation of the narrow-bezel design of the display panel.

Optionally, with continued reference to FIGS. 22 and 23, when the duration of the clock cycle T0 is 2*T, the clock cycle T0 includes a first time period T01 and a second time period T02 which are consecutive and each have a duration of T. Within one clock cycle T0, in the same shift register unit 101, both the effective pulse of the second clock signal ck2 and the effective pulse of the third clock signal ck3 are within the first time period T01 or the second time period T02. In this manner, within one clock cycle T0, the effective pulse of the second clock signal ck2 and the effective pulse of the third clock signal ck3 in the same shift register unit 101 are two consecutive effective pulses so that the effective pulses of the first gate signal S1 and the second gate signal S2 output by the shift register unit 101 may also be two consecutive effective pulses. When the first gate signal S1 and the second gate signal output by the same shift register unit 101 are used to control different modules in the same pixel circuit to be turned on or off, two modules in the pixel circuit may be turned on or off in two consecutive time periods, thereby shortening the drive cycle of the pixel circuit, increasing the refresh frequency of the display panel, and meeting the display requirements for the high refresh frequency of the display panel.

Optionally, with continued reference to FIGS. 22 and 23, within the one clock cycle T0, in the same shift register unit 101, the duration of the effective pulse of the first clock signal ck1 is before the duration of the effective pulse of the second clock signal ck2.

Since the drive control module 120 may control the signal transmission path between the input node Q0 and the first node Q1 according to the first clock signal ck1, for example, when the first clock signal ck1 is at an effective pulse, the drive control module 120 may transmit the signal of the input node Q0 to the first node Q1 so that the signal of the first node Q1 may be consistent with the signal of the input node Q0. Meanwhile, since the signal of the first node Q1 may control the first output transistor M31 in the first output module 130 and the third output transistor M41 in the second output module 14 to be turned on or off, when the first output transistor M31 and the third output transistor M41 are controlled to be turned on, the first output transistor M31 may transmit the second clock signal ck2 to the first output terminal OUT1, and the third output transistor M41 may transmit the third clock signal ck3 to the second output terminal OUT2.

Furthermore, in the forward scan mode, the signal of the input node Q0 in the y^{th}-stage shift register unit is consistent with the first gate signal or the second gate signal in the x^{th}-stage shift register unit, the duration of the effective pulse of the first gate signal in the x^{th}-stage shift register unit is before the duration of the effective pulse of the first gate signal in the y^{th}-stage shift register unit, and the duration of the effective pulse of the second gate signal in the x^{th}-stage shift register unit is before the duration of the effective pulse of the second gate signal in the y^{th}-stage shift register unit. Therefore, by setting the duration of the effective pulse of the first clock signal ck1 to be before the duration of the effective pulse of the second clock signal ck2, the effective pulse of the first gate signal or the second gate signal from the x^{th}-stage shift register unit may be written to the first node Q1 when the second clock signal ck2 jumps to an effective level. In this manner, the first output transistor M31 of the first output module 130 and the third output transistor M41 of the second output module 140 are controlled to be in on states before the second clock signal ck2 jumps to an effective level, the first output transistor M31 may transmit the complete effective pulse of the second clock signal ck2 to the first output terminal OUT1, and the third output transistor M41 may transmit the complete effective pulse of the third clock signal ck3 to the second output terminal OUT2 to ensure that the first gate signal S1 of the first output terminal OUT1 and the second gate signal S2 of the second output terminal OUT2 can have complete effective pulses, thereby enhancing the accuracy of the first gate signal S1 and the second gate signal S2 output by the shift register unit 101.

In an optional embodiment, with continued reference to FIGS. 22 and 23, when the x^{th}-stage shift register unit receives the first clock signal ck1x, the second clock signal ck2x and the third clock signal ck3x and the y^{th}-stage shift register unit receives the first clock signal ck1y, the second clock signal ck2y and the third clock signal ck3y, within one clock cycle in the forward scan mode, the duration of the effective pulse of the third clock signal ck3x in the x^{th}-stage shift register unit is before the duration of the effective pulse of the second clock signal ck2y in the y^{th}-stage shift register unit so that the duration of the effective pulse of the second gate signal S2x output by the x^{th}-stage shift register unit is before the duration of the effective pulse of the first gate signal S1y output by the y^{th}-stage shift register unit. In this manner, when the first gate signals S1 and the second gate signals S2 output by the stages of shift register units are used to control the operating process of the pixel circuit, the progressive scanning on the pixel circuits in the forward scan mode may be achieved.

Correspondingly, in the reverse scan mode, the signal of the input node Q0 in the y^{th}-stage shift register unit is consistent with the first gate signal or the second gate signal in the k^{th}-stage shift register unit, the duration of the effective pulse of the first gate signal in the k^{th}-stage shift register unit is before the duration of the effective pulse of the first gate signal in the y^{th}-stage shift register unit, and the duration of the effective pulse of the second gate signal in the k^{th}-stage shift register unit is before the duration of the effective pulse of the second gate signal in the y^{th}-stage shift register unit. Therefore, by setting the duration of the effective pulse of the first clock signal ck1 to be before the duration of the effective pulse of the second clock signal ck2, the accuracy of the first gate signal S1 and the second gate signal S2 output by the shift register unit 101 can also be enhanced. For the specific implementation, reference may be made to the above description in the forward scan mode, and the details are not repeated here.

In an optional embodiment, with continued reference to FIGS. 22 and 23, when the y^{th}-stage shift register unit receives the first clock signal ck1y, the second clock signal ck2y and the third clock signal ck3y and the k^{th}-stage shift register unit receives the first clock signal ck1k, the second clock signal ck2k and the third clock signal ck3k, within one clock cycle T0 in the reverse scan mode, the duration of the effective pulse of the third clock signal ck3k in the k^{th}-stage shift register unit is before the duration of the effective pulse of the second clock signal ck2y in the y^{th}-stage shift register unit so that the duration of the effective pulse of the second gate signal S2k output by the k^{th}-stage shift register unit is before the duration of the effective pulse of the first gate signal S1y output by the y^{th}-stage shift register unit. In this manner, when the first gate signals S1 and the second gate signals S2 output by the stages of shift register units are used to control the operating process of the pixel circuit, the progressive scanning on the pixel circuits in the reverse scan mode may be achieved.

Optionally, with continued reference to FIGS. 22 and 23, when the duration of the clock cycle T0 is 2*T, the clock cycle T0 includes a first time period T01 and a second time period T02 which are consecutive and each have a duration of T. Within one clock cycle T0, in the same shift register unit 101, the effective pulse of the first clock signal ck1 is within the first time period T01, and the effective pulse of the second clock signal ck2 and the effective pulse of the third clock signal ck3 are within the second time period T02, that is, within the same clock cycle, the first clock signal ck1 may be within a time period different from the time period where the second clock signal ck2 and the third clock signal ck3 are within. In this manner, the duration and the start time of the effective pulse of the first clock signal ck1 may be set flexibly to ensure the accuracy of the signal transmitted by the first node Q1, thereby enhancing the accuracy of the first gate signal S1 and the second gate signal S2 output by the shift register unit 101.

In another optional embodiment, FIG. 24 is a drive timing diagram of another shift register unit according to an embodiment of the present disclosure. With reference to FIGS. 22 and 24, when the duration of the clock cycle T0 is 2*T, the clock cycle T0 includes a first time period T01 and a second time period T02 which are consecutive and each have a duration of T. Within one clock cycle T0, in the same shift register unit 101, the effective pulse of the first clock signal ck1 and the effective pulse of the second clock signal ck2 are within the first time period T01, and the effective pulse of the third clock signal ck3 is within the second time period T02. In this case, the second clock signal ck2 and the third clock signal ck3 may be within different time periods of the same clock cycle T0, and as a result, the interval time between the effective pulse of the second clock signal ck2 and the effective pulse of the third clock signal ck3 may be set flexibly, thereby meeting the requirements for the interval time between the effective pulses of the first gate signal S1 and the second gate signal S2 output by the shift register unit 101.

It is to be understood that, within one clock cycle, for the same shift register unit, on the premise that the duration of the effective pulse of the first clock signal ck1 is before the duration of the effective pulse of the second clock signal ck2 and the duration of the effective pulse of the second clock signal ck2 is before the duration of the effective pulse of the third clock signal ck3, the interval time between the effective pulse of the first clock signal ck1 and the effective pulse of the second clock signal ck2, the interval time between the effective pulse of the second clock signal ck2 and the effective pulse of the third clock signal ck3, and the widths of the effective pulses of the first clock signal ck1, the second clock signal ck2 and the third clock signal ck3 may be designed according to actual requirements and are not specifically limited in the embodiments of the present disclosure.

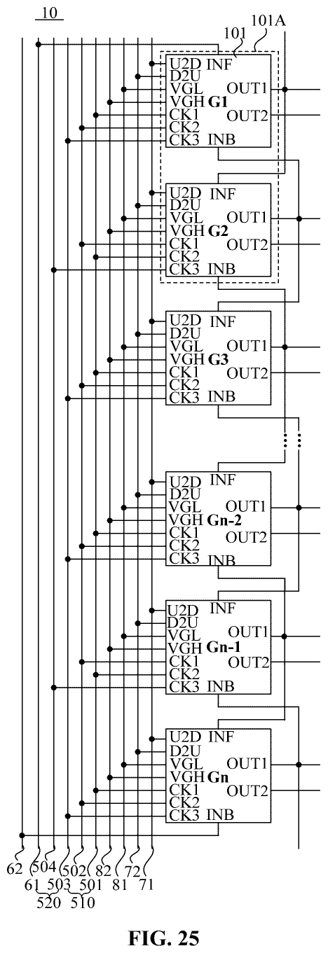

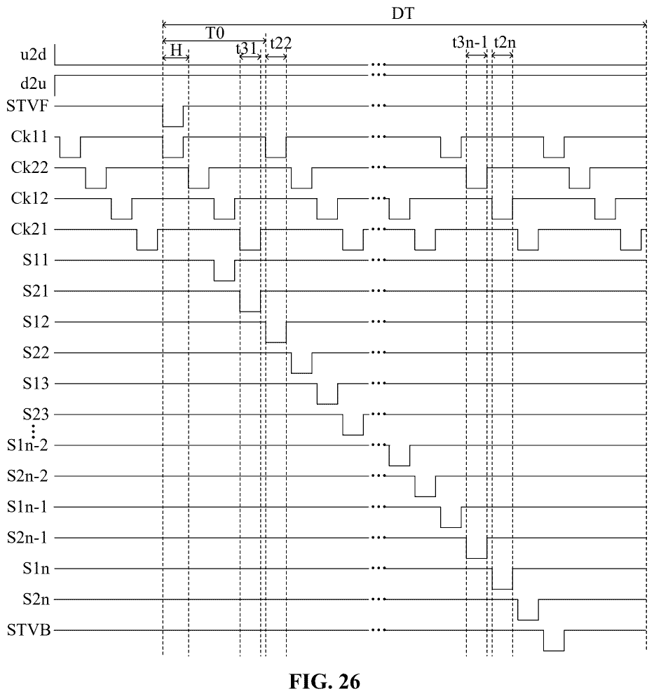

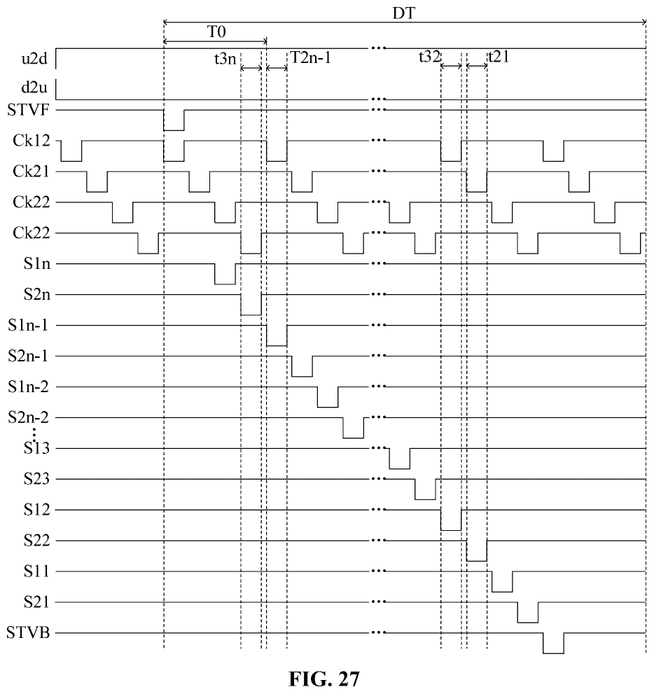

On the basis of the above embodiments, optionally, FIG. 25 is a structure diagram of another driver circuit according to an embodiment of the present disclosure, FIG. 26 is a drive timing diagram of a driver circuit in the forward scan mode according to an embodiment of the present disclosure, and FIG. 27 is a drive timing diagram of a driver circuit in the reverse scan mode according to an embodiment of the present disclosure. With reference to FIGS. 25 to 27, in the forward scan mode, the duration of the effective pulse of the second gate signal S2i output by the i^{th}-stage shift register unit Gi is before the duration of the effective pulse of the first gate signal S1i+1 output by the (i+1)^{th}-stage shift register unit Gi+1, and in the reverse scan mode, the duration of the effective pulse of the second gate signal S2i+1 output by the (i+1)^{th}-stage shift register unit Gi+1 is before the duration of the effective pulse of the first gate signal S1i output by the i^{th}-stage shift register unit Gi.

For example, when i is equal to 1 and i+1 is equal to 2, in the forward scan mode, the duration t31 of the effective pulse of the second gate signal S21 output by the first-stage shift register unit G1 is before the duration t22 of the effective pulse of the first gate signal S12 output by the second-stage shift register unit G2, and in the reverse scan mode, the duration t32 of the effective pulse of the second gate signal S22 output by the second-stage shift register unit G2 is before the duration t21 of the effective pulse of the first gate signal S11 output by the first-stage shift register unit G1.

Alternatively, when i is equal to n−1 and i+1 is equal to n, in the forward scan mode, the duration t3n−1 of the effective pulse of the second gate signal S2n−1 output by the (n−1)^{th}-stage shift register unit Gn−1 is before the duration t2n of the effective pulse of the first gate signal S1n output by the n^{th}-stage shift register unit Gn, and in the reverse scan mode, the duration t3n of the effective pulse of the second gate signal S2n output by the n^{th}-stage shift register unit Gn is before the duration t2n−1 of the effective pulse of the first gate signal S1n−1 output by the (n−1)^{th}-stage shift register unit Gn−1.

It is to be understood that, when the first output terminal OUT1 and the second output terminal OUT2 of the i^{th}-stage shift register unit Gi are electrically connected to the i^{th} row of pixel circuits to enable the first gate signal S1i and the second gate signal S2i output by the i^{th}-stage shift register unit Gi to control the reset stage and the data write stage of the i^{th} row of pixel circuits, respectively, the duration when the i^{th}-stage shift register unit Gi outputs the effective pulse of the first gate signal S1i is the reset stage of the i^{th} row of pixel circuits to reset the i^{th} row of pixel circuits during the duration, and the duration when the i^{th}-stage shift register unit Gi outputs the effective pulse of the second gate signal S2i is the data write stage of the i^{th} row of pixel circuits to enable the data write signal to the i^{th} row of pixel circuits during the duration. Similar, the first output terminal OUT1 and the second output terminal OUT2 of the (i+1)^{th}-stage shift register unit are electrically connected to the (i+1)^{th} row of pixel circuits to control the reset stage and the data write stage of the (i+1)^{th} row of pixel circuits, respectively, the (i+1)^{th} row of pixel circuits may be reset during the duration when the (i+1)^{th}-stage shift register unit outputs the effective pulse of the first gate signal S1i+1, and the data write signal may be written to the (i+1)^{th} row of pixel circuits during the duration when the (i+1)^{th}-stage shift register unit outputs the effective pulse of the second gate signal S2i+1.

In the forward scan mode, by setting the duration of the effective pulse of the second gate signal S2i output by the i^{th}-stage shift register unit Gi to be before the duration of the effective pulse of the first gate signal S1i+1 output by the (i+1)^{th}-stage shift register unit Gi+1, the data write stage of the i^{th} row of pixel circuits may be before the reset stage of the (i+1)^{th} row of pixel circuits, that is, the (i+1)^{th} row of pixel circuits enter the reset stage only after the i^{th} row of pixel circuits complete the reset and data write operations, thereby ensuring that the reset and data write operations of the i^{th} row of pixel circuits do not interfere with the reset and data write operations of the (i+1)^{th} row of pixel circuits.

Similar, in the reverse scan mode, the duration of the effective pulse of the second gate signal S2i+1 output by the (i+1)^{th}-stage shift register unit Gi+1 is before the duration of the effective pulse of the first gate signal S1i output by the i^{th}-stage shift register unit Gi, and the i^{th} row of pixel circuits enter the reset stage only after the (i+1)^{th} row of pixel circuits complete the reset and data write operations, thereby ensuring that the reset and data write operations of the i^{th} row of pixel circuits do not interfere with the reset and data write operations of the (i+1)^{th} row of pixel circuits.

Optionally, with continued reference to FIGS. 25 to 27, when x=y−m and k=y+m, the display panel further includes 2*m first clock signal lines 510 and 2*m second clock signal lines 520, and 2*m adjacent stages of shift register units 101 constitute a shift register unit group 101A, where m is a positive integer. For example, when m is equal to 1, two adjacent stages of shift register units 101 constitute a shift register unit group 101A. For example, the first-stage shift register unit G1 and the second-stage shift register unit G2 constitute a shift register unit group 101A. In this case, the display panel may include two first clock signal lines 510 (that is, first clock signal lines 501 and 502) and two second clock signal lines 520 (that is, second clock signal lines 503 and 504).

The display duration DT of one frame of the display panel includes multiple clock cycles T0. The duration of the clock cycle T0 is greater than or equal to 2*m*H, where H is a clock unit duration. Within one clock cycle T0, effective pulses of clock signals transmitted by the first clock signal lines 510 are sequentially shifted; within one clock cycle T0, effective pulses of clock signals transmitted by the second clock signal lines 520 are sequentially shifted. For example, when m is equal to 1, the clock cycle T0 may be equal to 4*H. In this case, the effective pulses of the clock signal Ck11 transmitted by the first clock signal line 501 and the clock signal Ck12 transmitted by the first clock signal line 502 are sequentially shifted, the effective pulses of the clock signal Ck21 transmitted by the second clock signal line 503 and the clock signal Ck22 transmitted by the second clock signal line 504 are sequentially shifted, and the effective pulses of the clock signals Ck11, Ck22, Ck12 and Ck21 are sequentially shifted within one clock cycle T0.

In the same shift register unit group 101A, the first clock terminal CK of a stage of shift register unit 101 among the 2*m adjacent stages of shift register units 101 is electrically connected to a corresponding one of the first clock signal lines 510, and the third clock terminal CK of a stage of shift register unit 101 among the 2*m adjacent stages of shift register units 101 is electrically connected to a corresponding one of the second clock signal lines 520; the second clock terminal CK2 of an (i+m)^{th}-stage shift register unit Gi+m and the first clock terminal CK1 of the i^{th}-stage shift register unit Gi are electrically connected to the same first clock signal line 510, where i is a positive integer less than or equal to n. For example, the first clock terminal CK1 of the first-stage shift register unit G1 is electrically connected to the first clock signal line 501, the first clock terminal CK1 of the second-stage shift register unit G2 is electrically connected to the first clock signal line 502, the third clock terminal CK3 of the first-stage shift register unit G1 is electrically connected to the second clock signal line 503, the third clock terminal CK3 of the second-stage shift register unit G2 is electrically connected to the second clock signal line 504, the second clock terminal CK2 of the second-stage shift register unit G2 is electrically connected to the first clock signal line 501, and the second clock terminal CK2 of the third-stage shift register unit G3 is electrically connected to the first clock signal line 502.

For example, when i is equal to 1 and m is equal to 1 as an example, in the same stage shift register unit 101, the first clock terminal CK1 may control the signal transmission path between the forward input terminal INF or the reverse input terminal INB and the first node, the second clock terminal CK2 controls the duration of the effective pulse of the first gate signal S1 of the first output terminal OUT1, and the third clock terminal CK3 controls the duration of the effective pulse of the second gate signal S2 of the second output terminal OUT2. In the forward scan mode, when the first shift register unit G1 outputs the effective pulse of the first gate signal S11, by setting the clock signal Ck12 received by the first clock terminal CK1 of the second-stage shift register unit G2 to have an effective pulse, the effective pulse of the first gate signal S11 may be transmitted to the first node of the second-stage shift register unit G2 so that the signal of the first node of the second-stage shift register unit G2 may control the clock signal Ck11 received by the second clock terminal CK2 to be transmitted to the first output terminal OUT1 and the clock signal Ck22 received by the third clock terminal CK3 to be transmitted to the second output terminal OUT2. By electrically connecting the first clock terminal CK1 of the first-stage shift register unit G1 to the first clock signal line 501, electrically connecting the first clock terminal CK1 of the second-stage shift register unit G2 to the first clock signal line 502, electrically connecting the third clock terminal CK3 of the first-stage shift register unit G1 to the second clock signal line 503, electrically connecting the third clock terminal CK3 of the second-stage shift register unit G2 to the second clock signal line 504, electrically connecting the second clock terminal CK2 of the first-stage shift register unit G1 to the first clock signal line 502 and electrically connecting the second clock terminal CK2 of the second-stage shift register unit G2 to the first clock signal line 501, the effective pulses of the first gate signal S11 and the second gate signal S21 output by the first-stage shift register unit G1 are sequentially shifted, and the duration of the effective pulse of the first gate signal S12 output by the second-stage shift register unit G2 is after the duration of the effective pulse of the second gate signal S21 output by the first-stage shift register unit G1. Consequently, in the forward scan mode, the effective pulses of the first gate signals (S11, S12, S13, . . . , S1n−2, S1n−1, and S1n) and the second gate signals (S21, S22, S23, . . . , S2n−2, S2n−1, and S2n) output by the first-stage shift register unit G1 to the n^{th}-stage shift register unit Gn are sequentially shifted.

Correspondingly, in the reverse mode, by electrically connecting the first clock terminal CK1 of the (n−1)^{th}-stage shift register unit Gn−1 to the first clock signal line 501, electrically connecting the first clock terminal CK1 of the n^{th}-stage shift register unit Gn to the first clock signal line 502, electrically connecting the third clock terminal CK3 of the (n−1)^{th}-stage shift register unit Gn−1 to the second clock signal line 503, electrically connecting the third clock terminal CK3 of the n^{th}-stage shift register unit Gn to the second clock signal line 504, electrically connecting the second clock terminal CK2 of the (n−1)^{th}-stage shift register unit Gn−1 to the first clock signal line 502 and electrically connecting the second clock terminal CK2 of the n^{th}-stage shift register unit Gn to the first clock signal line 501, the effective pulses of the first gate signals (S1n, S1n−1, S1n−2, . . . , S13, S12, and S11) and the second gate signals (S2n, S2n−1, S2n−2, . . . , S23, S22, and S21) output by the n^{th}-stage shift register unit Gn to the first-stage shift register unit G1 are sequentially shifted.

Furthermore, the first clock terminal CK1 of the i^{th}-stage shift register unit Gi and the first clock terminal CK1 of the (i+2*m)^{th}-stage shift register unit Gi+2*m are electrically connected to the same first clock signal line 510, and the third clock terminal CK3 of the i^{th}-stage shift register unit Gi and the third clock terminal CK3 of the (i+2*m)^{th}-stage shift register unit Gi+2*m are electrically connected to the same second clock signal line 520. Therefore, on the premise that the stages of shift register units 101 accurately output the first gate signals S1 and the second gate signals S2, the number of clock signal lines can be reduced, thereby simplifying the structure of the display panel and facilitating the implementation of the narrow-bezel design of the display panel.

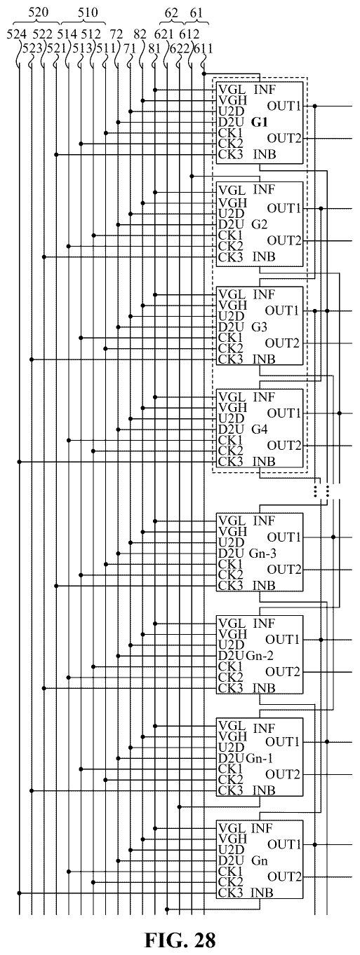

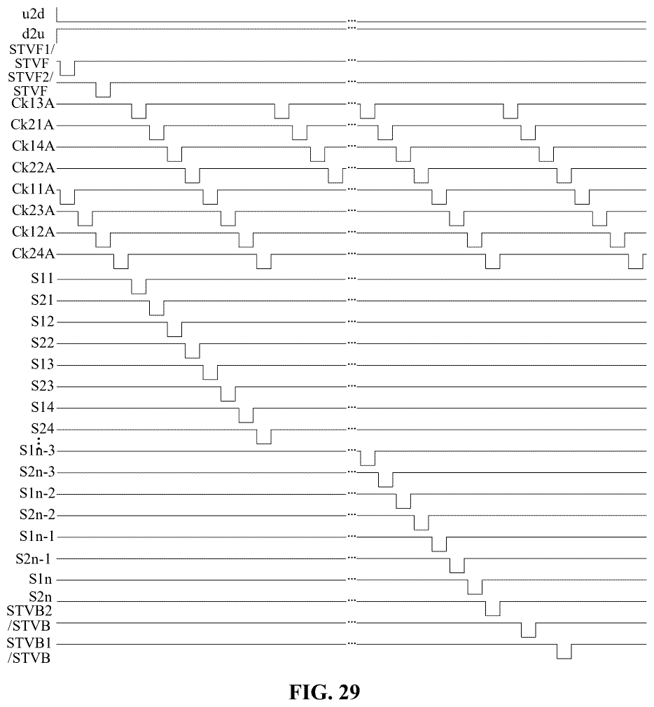

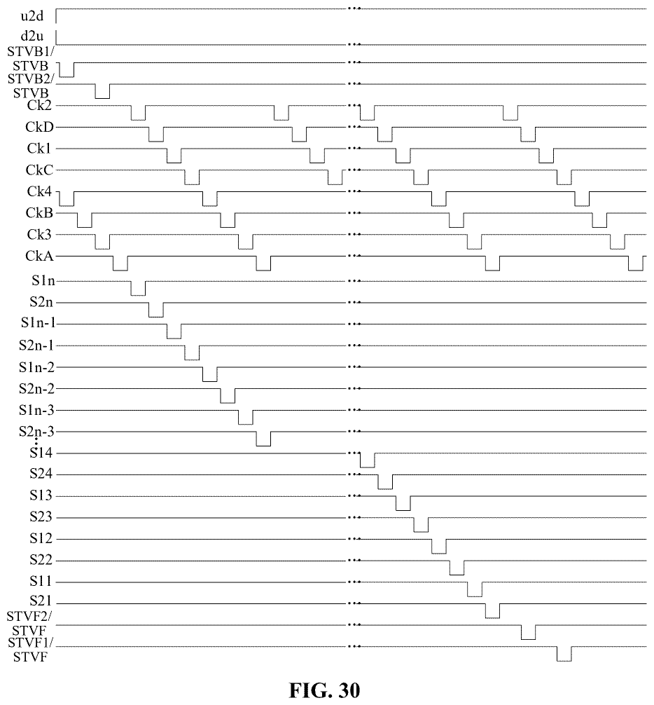

It is to be noted that the technical solutions of the embodiments of the present disclosure are illustrated above using the case in which m is equal to 1. However, m may also be a positive integer greater than 1 in the embodiments of the present disclosure. For example, as shown in FIGS. 28 to 30, when m is equal to 2, the display panel may include four first clock signal lines 510 (511, 512, 513 and 514) and four second clock signal lines 520 (521, 522, 523 and 524). The first clock signal lines 511, 512, 513 and 514 transmit the clock signals Ck11A, Ck12A, Ck13A and Ck14A, respectively, and the second clock signal lines 520 (521, 522, 523 and 524) transmit the clock signals Ck21A, Ck22A, Ck23A and Ck24A, respectively. In this case, within one clock cycle, the effective pulses of the clock signals Ck13A, Ck21A, Ck14A, Ck22A, Ck11A, Ck23A, Ck12A and Ck24A are sequentially shifted. Four adjacent stages of shift register units 101 constitute a shift register unit group 101A. For example, the first-stage shift register unit G1, the second-stage shift register unit G2, the third-stage shift register unit G3 and the fourth-stage shift register unit G4 constitute a shift register unit group 101A, . . . , and the (n−3)^{th}-stage shift register unit Gn−3, the (n−2)^{th}-stage shift register unit Gn−2, the (n−1)^{th}-stage shift register unit Gn−1 and the n^{th}-stage shift register unit Gn constitute a shift register unit group 101A. On the premise that the core inventive points in the embodiments of the present disclosure are achieved, the value of m is not specifically limited in the embodiments of the present disclosure.

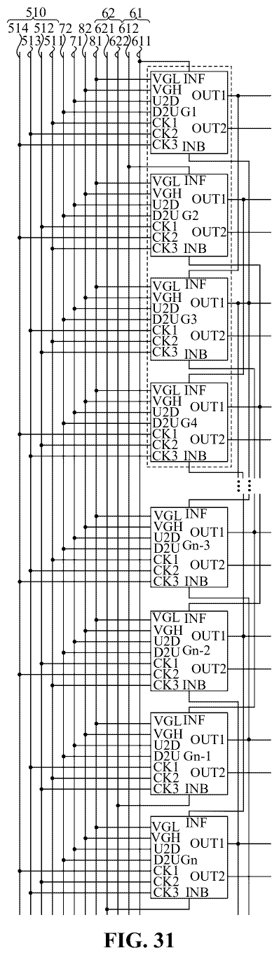

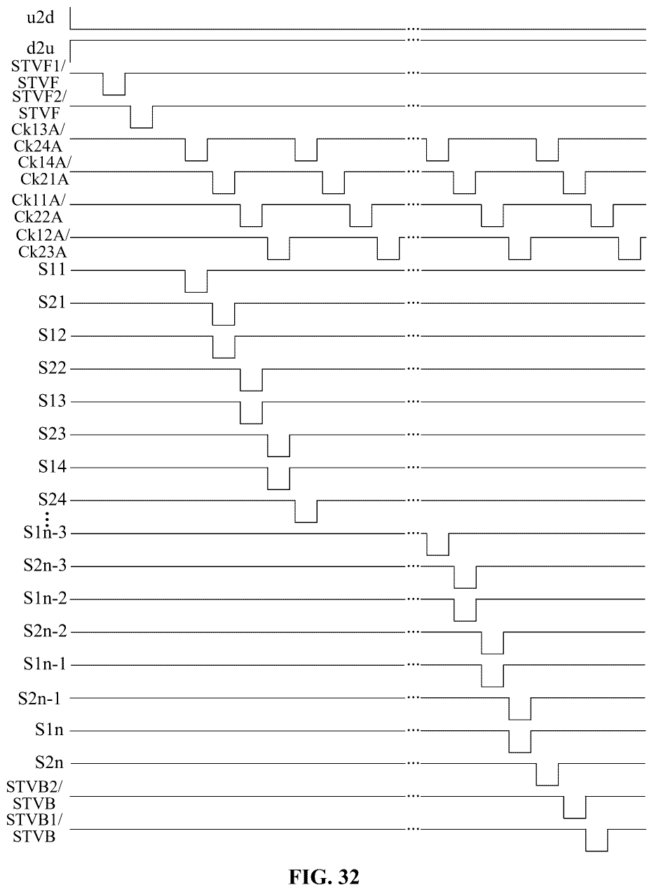

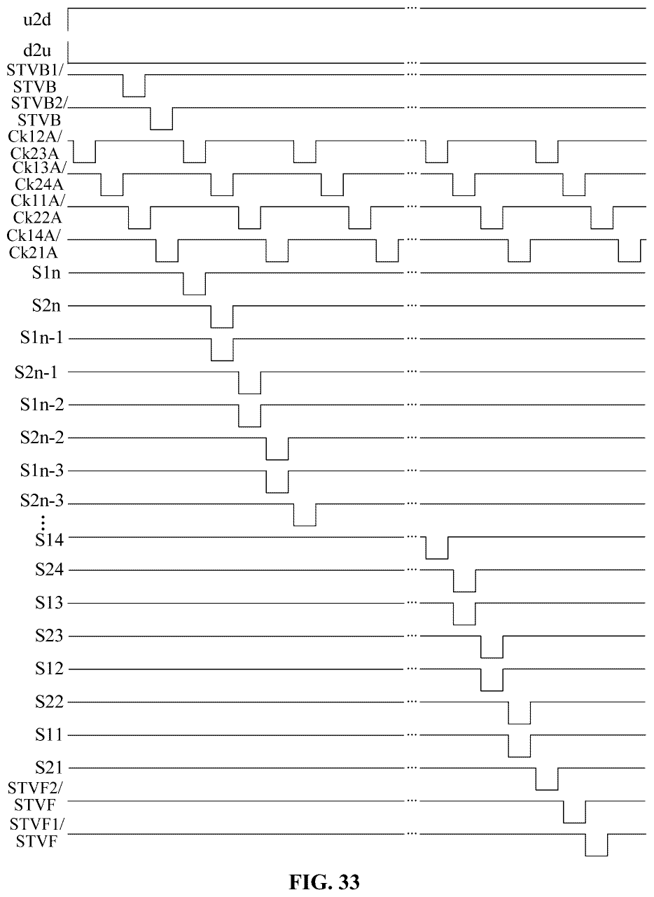

In another optional embodiment, with reference to FIGS. 31 to 33, when m is greater than 1, the third clock signal of the i^{th}-stage shift register unit Gi is the same as the first clock signal of an (i+m+1)^{th}-stage shift register unit Gi+m+1. For example, when m is equal to 2, the third clock signal Ck21 of the first-stage shift register unit G1 may be the same as the first clock signal Ck14 of the fourth-stage shift register unit G4. In this case, both the third clock terminal CK3 of the first-stage shift register unit G1 and the first clock terminal CK1 of the fourth-stage shift register unit G4 may be electrically connected to the first clock signal line 514 to allow the second clock signal line used to transmit the clock signal Ck21 to be reused as the first clock signal line 514. Therefore, the number of clock signals supplied to the driver circuit 10 can be reduced, thereby lowering the driving cost of the driver circuit 10; furthermore, the number of clock signal lines can be reduced, thereby facilitating the implementation of the narrow-bezel design of the display panel.

It is to be understood that, when m is equal to 2, the second clock terminal CK2 of the third-stage shift register unit G3 and the first clock terminal CK1 of the first-stage shift register unit G1 are electrically connected to the same first clock signal line 511, the second clock terminal CK2 of the fourth-stage shift register unit G4 and the first clock terminal CK1 of the second-stage shift register unit G2 are electrically connected to the same first clock signal line 512, and the third clock terminal CK3 of the third-stage shift register unit G3 is also electrically connected to the first clock signal line 512. In this manner, in the forward scan mode, the effective pulses of the first gate signal S13 and the second gate signal S23 output by the third-stage shift register unit G3 are sequentially shifted, and the effective pulse of the second gate signal S23 output by the third-stage shift register unit G3 overlaps with the effective pulse of the first gate signal S14 output by the fourth-stage shift register unit G4. In the reverse scan mode, the effective pulses of the first gate signal S14 and the second gate signal S24 output by the fourth-stage shift register unit G4 are sequentially shifted, and the effective pulse of the second gate signal S24 output by the fourth-stage shift register unit G4 overlaps with the effective pulse of the first gate signal S13 output by the third-stage shift register unit G3.

In an optional embodiment, with continued reference to FIGS. 31 to 33, in the forward mode, the duration of the effective pulse of the first gate signal S1i output by the i^{th}-stage shift register unit Gi is before the duration of the effective pulse of the first gate signal S1i+1 output by the (i+1)^{th}-stage shift register unit Gi+1, and the duration of the effective pulse of the second gate signal S2i output by the i^{th}-stage shift register unit Gi overlaps with the duration of the effective pulse of the first gate signal S1i+1 output by the (i+1)^{th}-stage shift register unit Gi+1; in the reverse scan mode, the duration of the effective pulse of the first gate signal S1i+1 output by the (i+1)^{th}-stage shift register unit Gi+1 is before the duration of the effective pulse of the first gate signal S1i output by the i^{th}-stage shift register unit Gi, and the duration of the effective pulse of the second gate signal S2i+1 output by the (i+1)^{th}-stage shift register unit Gi+1 overlaps with the duration of the effective pulse of the first gate signal S1i output by the i^{th}-stage shift register unit Gi, where i is a positive integer less than or equal to n.

When the first gate signal S1i and the second gate signal S2i output by the i^{th}-stage shift register unit Gi are used to control the reset stage and the data write stage of the i^{th} row of pixel circuits respectively and the first gate signal S1i+1 and the second gate signal S2i+1 output by the (i+1)^{th}-stage shift register unit Gi+1 are used to control the reset stage and the data write stage of the (i+1)^{th} row of pixel circuits respectively, by setting the duration of the effective pulse of the second gate signal S2 and the duration of the effective pulse of the first gate signal S1 in two adjacent stages of shift register units to overlap with each other, for two adjacent rows of pixel circuits, the data write stage of the preceding row of pixel circuits and the reset stage of the subsequent row of pixel circuits are the same stage in the forward scan mode, and the data write stage of the subsequent row of pixel circuits and the reset stage of the preceding row of pixel circuits are the same stage in the reverse scan mode, thereby shortening the drive cycle of the display panel and improving the display performance of the display panel.

It is to be noted that the clock signals received by the first, second, and third clock terminals of the shift register unit are illustrated above using an example in which the forward input terminal of the y^{th}-stage shift register unit is electrically connected to the first input terminal of the x^{th}-stage shift register unit and the reverse input terminal of the y^{th}-stage shift register unit Gy is electrically connected to the first input terminal of the k^{th}-stage shift register unit. In the embodiments of the present disclosure, when the forward input terminal of the y^{th}-stage shift register unit is electrically connected to the second output terminal of the x^{th}-stage shift register unit and the reverse input terminal of the y^{th}-stage shift register unit is electrically connected to the second output terminal of the k^{th}-stage shift register unit, the first clock signals received by the first clock terminals of the stages of shift register units may be adaptively adjusted to meet the requirement for sequential shifting of the first gate signals and second gate signals output by the stages of shift register units in both the forward scan mode and the reverse scan mode.

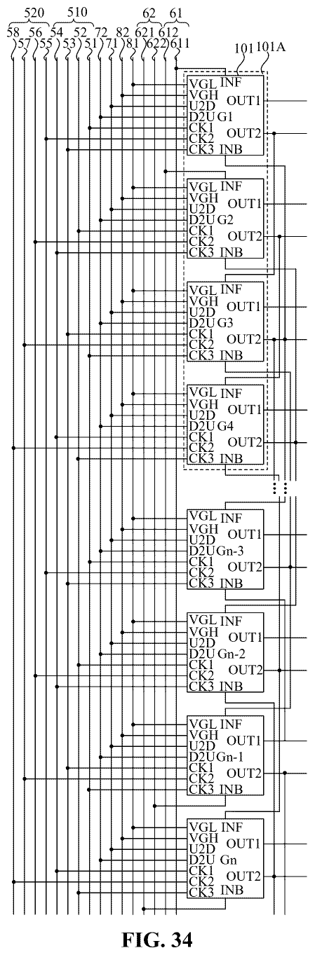

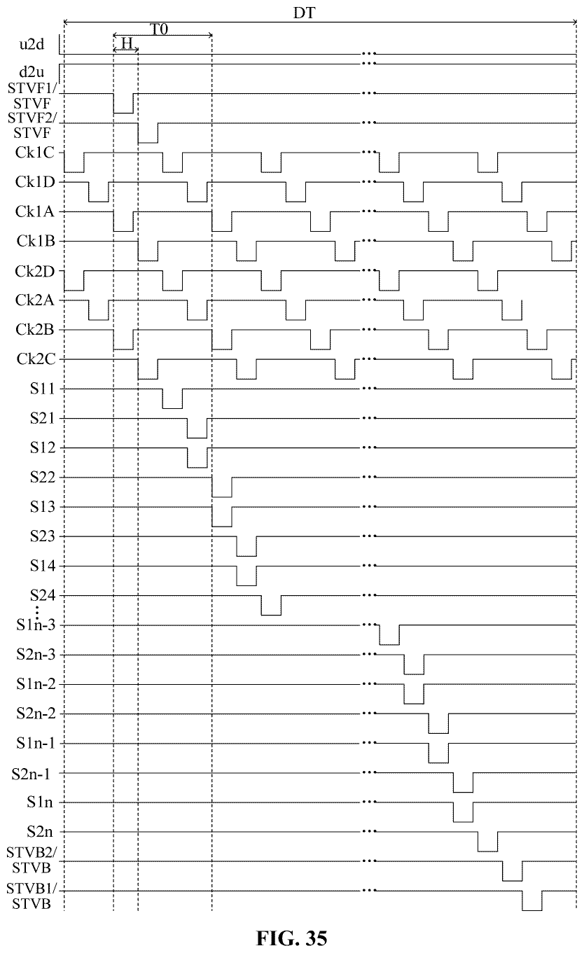

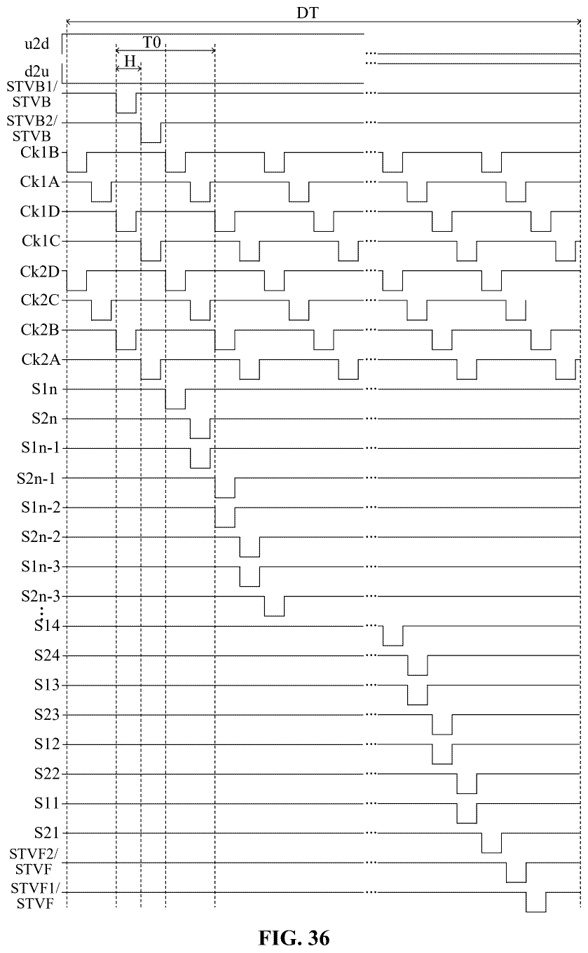

In an optional embodiment, with reference to FIGS. 34 to 36, when x=y−m and k=y+m, the display panel further includes 2*m first clock signal lines 510 and 2*m second clock signal lines 520. The display duration DT of one frame of the display panel includes multiple clock cycles T0. The duration of the clock cycle T0 is greater than or equal to 2*m*H, where H is a clock unit duration. Within one clock cycle T0, effective pulses of clock signals transmitted by the first clock signal lines 510 are sequentially shifted; within one clock cycle T0, effective pulses of clock signals transmitted by the second clock signal lines 520 are sequentially shifted. 2*m adjacent stages of shift register units 101 constitute a shift register unit group 101A. In the same shift register unit group 101A, the first clock terminal CK1 of a stage of shift register unit among the 2*m adjacent stages of shift register units 101 is electrically connected to a corresponding one of the first clock signal lines 510, and the second clock terminal CK2 of a stage of shift register unit among the 2*m adjacent stages of shift register units 101 is electrically connected to a corresponding one of the second clock signal lines 520. The third clock terminal CK3 of the (i+m)^{th}-stage shift register unit Gi+m and the first clock terminal CK1 of the i^{th}-stage shift register unit Gi are electrically connected to the same first clock signal line 510, where i is a positive integer less than or equal to n.

For example, when m is equal to 2, the display panel may include four first clock signal lines 510 and four second clock signal lines 520, that is, the first clock signal lines 51, 52, 53 and 54 and the second clock signal lines 55, 56, 57 and 58. The first clock signal lines 51, 52, 53 and 54 transmit the clock signals Ck1A, Ck1B, Ck1C and Ck1D, respectively, and the second clock signal lines 55, 56, 57 and 58 transmit the clock signals Ck2A, Ck2B, Ck2C and Ck2D, respectively. Within one clock cycle T0, the effective pulses of the clock signals Ck1A, Ck1B, Ck1C and Ck1D are sequentially shifted, and the effective pulses of the clock signals Ck2A, Ck2B, Ck2C and Ck2D are sequentially shifted.

Correspondingly, four adjacent stages of shift register units 101 constitute a shift register unit group 101A. For example, the first-stage shift register unit G1, the second-stage shift register unit G2, the third-stage shift register unit G3 and the fourth-stage shift register unit G4 constitute a shift register unit group 101A, . . . , and the (n−3)^{th}-stage shift register unit Gn−3, the (n−2)^{th}-stage shift register unit Gn−2, the (n−1)^{th}-stage shift register unit Gn−1 and the n^{th}-stage shift register unit Gn constitute a shift register unit group 101A. In this case, the first clock terminals CK1 of the first-stage shift register unit G1, the second-stage shift register unit G2, the third-stage shift register unit G3 and the fourth-stage shift register unit G4 are electrically connected to the first clock signal lines 51, 52, 53 and 54, respectively, the second clock terminals CK2 of the first-stage shift register unit G1, the second-stage shift register unit G2, the third-stage shift register unit G3 and the fourth-stage shift register unit G4 are electrically connected to the second clock signal lines 55, 56, 57 and 58, respectively, and the third clock terminals CK3 of the first-stage shift register unit G1, the second-stage shift register unit G2, the third-stage shift register unit G3 and the fourth-stage shift register unit G4 are electrically connected to the first clock signal lines 53, 54, 51 and 52, respectively. In this manner, the clock signal Ck1A received by the first clock terminal CK1 of the first-stage shift register unit G1 may be reused as the clock signal of the third clock terminal CK3 of the third-stage shift register unit G3, and the clock signal Ck1B received by the first clock terminal CK1 of the second-stage shift register unit G2 may be reused as the clock signal of the third clock terminal CK3 of the fourth-stage shift register unit G4. Therefore, the first gate signal and the second gate signal of the same shift register unit 101 may be sequentially shifted, the first gate signals output by all stages of shift register units 101 may be sequentially shifted in both the forward and reverse scan modes, and the second gate signals output by all stages of shift register units 101 may be sequentially shifted in both the forward and reverse scan modes, thereby meeting the scan requirements of the display panel in different modes.

On the basis of the above embodiments, optionally, when m is greater than 1, the second clock signal of the i^{th}-stage shift register unit Gi is the same as the first clock signal of an (i+m−1)^{th}-stage shift register unit Gi+m−1. For example, when m is equal to 2, the second clock signal Ck2A of the first-stage shift register unit G1 may be the same as the first clock signal Ck1B of the second-stage shift register unit G2. In this case, both the first clock terminal CK1 of the first-stage shift register unit G1 and the second clock terminal CK2 of the second-stage shift register unit G2 may be electrically connected to the first clock signal line 52 to allow the second clock signal line 55 used to transmit the clock signal Ck2A to be reused as the first clock signal line 51. Therefore, the number of clock signals supplied to the driver circuit 10 can be reduced, thereby lowering the driving cost of the driver circuit 10; furthermore, the number of clock signal lines can be reduced, thereby facilitating the implementation of the narrow-bezel design of the display panel.

On the basis of the above embodiments, optionally, with reference to any one of FIGS. 25 to 36, when x=y−m and k=y+m, the display panel further includes m first start signal lines 61 and m second start signal lines 62, where m is a positive integer. The forward input terminal INF of a stage of shift register unit among the first-stage shift register unit G1 to an m^{th}-stage shift register unit Gm is electrically connected to a corresponding one of the first start signal lines 61, and the reverse input terminal INB of a stage of shift register unit among an (n−m+1)^{th}-stage shift register unit Gn−m+1 to the n^{th}-stage shift register unit Gn is electrically connected to a corresponding one of the second start signal lines 62. In the forward scan mode, the first start signal lines 61 sequentially transmit the effective pulse of a first start signal STVF, and in the reverse scan mode, the second start signal lines 62 sequentially transmit the effective pulse of a second start signal STVB.

For example, when m is equal to 2, the first-stage shift register unit G1 and the second-stage shift register unit G2 may be electrically connected to the first start signal lines 611 and 612, respectively, and the n^{th}-stage shift register unit Gn and the (n−1)^{th}-stage shift register unit Gn^{th}−1 are electrically connected to the second start signal lines 621 and 622, respectively. Therefore, in the forward scan mode, the effective pulses of the first start signal STVF1 transmitted by the first start signal line 611 and the first start signal STVF2 transmitted by the first start signal line 612 are sequentially shifted, the effective pulses of the first gate signal S11 output by the first-stage shift register unit G1 and the first gate signal S12 output by the second-stage shift register unit G2 may be sequentially shifted, and the effective pulses of the second gate signal S21 output by the first-stage shift register unit G1 and the second gate signal S22 output by the second-stage shift register unit G2 are sequentially shifted to ensure that the third-stage shift register unit G3 to the n^{th}-stage shift register unit Gn which are directly or indirectly cascaded with the first-stage shift register unit G1 and the second-stage shift register unit G2 can sequentially output the effective pulses of the first gate signal S1 and the second gate signals S2; in the reverse scan mode, the effective pulses of the second start signal STVB1 transmitted by the second start signal line 621 and the second start signal STVB2 transmitted by the second start signal line 622 are sequentially shifted, the effective pulses of the first gate signal S1n output by the n^{th}-stage shift register unit Gn and the first gate signal S1n−1 output by the (n−1)^{th}-stage shift register unit Gn−1 may be sequentially shifted, and the effective pulses of the second gate signal S2n output by the n^{th}-stage shift register unit Gn and the second gate signal S2n−1 output by the (n−1)^{th}-stage shift register unit Gn−1 are sequentially shifted to ensure that the (n−2)^{th}-stage shift register unit Gn−2 to the first-stage shift register unit G1 which are directly or indirectly cascaded with the n^{th}-stage shift register unit Gn and the (n−1)^{th}-stage shift register unit Gn−1 can sequentially output the effective pulses of the first gate signal S1 and the second gate signals S2, thereby meeting the scan requirements of the display panel in different modes.

Furthermore, the display panel may further include a first signal transmission line 81, a second signal transmission line 82, a third signal transmission line 71 and a fourth signal transmission line 72. The first signal transmission line 81 is used to transmit the first voltage signal Vgl, the second signal transmission line 82 is used to transmit the second voltage signal Vgh, the third signal transmission line 71 is used to transmit the forward scan control signal u2d, and the fourth signal transmission line 72 is used to transmit the reverse scan control signal d2u. In this case, the first voltage terminals VGL of the stages of shift register units 101 are electrically connected to the first signal transmission line 81, the second voltage terminals VGH of the stages of shift register units 101 are electrically connected to the second signal transmission line 82, the forward control terminals U2D of the stages of shift register units 101 are electrically connected to the third signal transmission line 71, and the reverse control terminals D2U of the stages of shift register units 101 are electrically connected to the fourth signal transmission line 72. In this manner, the stages of shift register units 101 can accurately receive the first voltage signal Vgl, the second voltage signal Vgh, the forward scan control signal u2d and the reverse scan control signal d2u to enable the stages of shift register units 101 to accurately output the first gate signal and second gate signal, thereby improving the display performance of the display panel while meeting the scan requirements of the display panel in different modes.

Based on the same inventive concept, embodiments of the present disclosure further provide a display device. The display device includes the display panel provided by any embodiment of the present disclosure. Therefore, the display device has the technical features of the display panel and the method for driving the display panel provided by the embodiments of the present disclosure and thus can achieve the beneficial effects of the display panel provided by the embodiments of the present disclosure. For similarities, reference may be made to the above description of the display panel provided by the embodiments of the present disclosure, and the details are not repeated here.

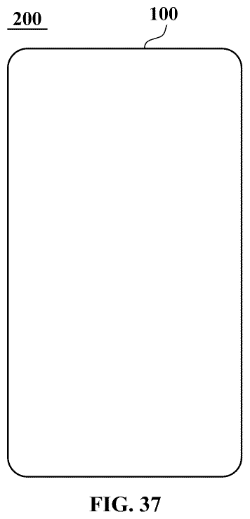

Exemplarily, FIG. 37 is a structure diagram of a display device according to an embodiment of the present disclosure. As shown in FIG. 37, the display device 200 includes the display panel 100 provided in the embodiments of the present disclosure. The display device 200 provided by the embodiments of the present disclosure may be any electronic product having a display function. The electronic product includes, but is not limited to, a mobile phone, a television, a laptop, a desktop display, a tablet, a digital camera, a smart bracelet, smart glasses, an in-vehicle display, a medical device, an industrial control device or an interactive touch terminal, which is not specially limited in the embodiments of the present disclosure

It is to be noted that the preceding are preferred embodiments of the present disclosure and technical principles used therein. It is to be understood by those skilled in the art that the present disclosure is not limited to the embodiments described herein. Those skilled in the art can make various apparent modifications, adaptations, and substitutions without departing from the scope of the present disclosure. Therefore, although the present disclosure has been described in detail through the above embodiments, the present disclosure is not limited to the above embodiments and may include other equivalent embodiments without departing from the concept of the present disclosure. The scope of the present disclosure is determined by the scope of the appended claims.

What is claimed is:

1. A display panel, comprising a driver circuit, wherein the driver circuit comprises n stages of cascaded shift register units, wherein n is a positive integer greater than or equal to 2;
a shift register unit among the n stages of cascaded shift register units comprises a scan control module, a drive control module, a first output module, a second output module, a forward input terminal, a reverse input terminal, a forward control terminal, a reverse control terminal, a first clock terminal, a second clock terminal, a third clock terminal, a first output terminal and a second output terminal; in a same shift register unit among the n stages of cascaded shift register units, the scan control module is electrically connected to the forward input terminal, the reverse input terminal, the forward control terminal, the reverse control terminal and an input node, the drive control module is at least electrically connected to the input node, the first clock terminal, a first node and a second node, the first output module is at least electrically connected to the first node, the second node, the second clock terminal and the first output terminal, and the second output module is at least electrically connected to the first node, the second node, the third clock terminal and the second output terminal;
the first output terminal or the second output terminal of an x^{th}-stage shift register unit is electrically connected to the forward input terminal of a y^{th}-stage shift register unit, and the reverse input terminal of the y^{th}-stage shift register unit is electrically connected to the first output terminal or the second output terminal of a k^{th}-stage shift register unit; wherein 1≤x<y<k≤n, and x, y and k are positive integers;
in the same shift register unit, an effective pulse of a first gate signal output from the first output terminal and an effective pulse of a second gate signal output from the second output terminal are sequentially shifted;
an operating mode of the display panel comprises a forward scan mode and a reverse scan mode; in the forward scan mode, a first-stage shift register unit to an n^{th}-stage shift register unit sequentially output the effective pulse of the first gate signal and sequentially output the effective pulse of the second gate signal; in the reverse scan mode, the n^{th}-stage shift register unit to the first-stage shift register unit sequentially output the effective pulse of the first gate signal and sequentially output the effective pulse of the second gate signal.

2. The display panel according to claim 1, wherein the forward control terminal is configured to receive a forward scan control signal, and the reverse control terminal is configured to receive a reverse scan control signal;
in the forward scan mode, the forward scan control signal is at an effective level, and the reverse scan control signal is at an ineffective level;
in the reverse scan mode, the reverse scan control signal is at an effective level, and the forward scan control signal is at an ineffective level.

3. The display panel according to claim 1, wherein the scan control module comprises a forward scan control transistor and a reverse scan control transistor;
a gate of the forward scan control transistor is electrically connected to the forward control terminal, a first electrode of the forward scan control transistor is electrically connected to the forward input terminal, and a second electrode of the forward scan control transistor is electrically connected to the input node;
a gate of the reverse scan control transistor is electrically connected to the reverse control terminal, a first electrode of the reverse scan control transistor is electrically connected to the reverse input terminal, and a second electrode of the reverse scan control transistor is electrically connected to the input node.

4. The display panel according to claim 1, wherein a display duration of one frame of the display panel comprises a plurality of clock cycles; within one clock cycle of the plurality of clock cycles, in the same shift register unit, an effective pulse of a second clock signal of the second clock terminal and an effective pulse of a third clock signal of the third clock terminal are sequentially shifted.

5. The display panel according to claim 4, wherein when a duration of a clock cycle among the plurality of clock cycles is 2*T, the clock cycle comprises a first time period and a second time period which are consecutive and each have a duration of T;
within the one clock cycle, in the same shift register unit, the effective pulse of the second clock signal and the effective pulse of the third clock signal are both within the first time period or the second time period.

6. The display panel according to claim 4, wherein within the one clock cycle, in the same shift register unit, a duration of an effective pulse of a first clock signal is before a duration of the effective pulse of the second clock signal.

7. The display panel according to claim 6, wherein when a duration of a clock cycle among the plurality of clock cycles is 2*T, the clock cycle comprises a first time period and a second time period which are consecutive and each have a duration of T;
within the one clock cycle, in the same shift register unit, the effective pulse of the first clock signal is within the first time period, and the effective pulse of the second clock signal and the effective pulse of the third clock signal are within the second time period.

8. The display panel according to claim 6, wherein when a duration of a clock cycle among the plurality of clock cycles is 2*T, the clock cycle comprises a first time period and a second time period which are consecutive and each have a duration of T;
within the one clock cycle, in the same shift register unit, the effective pulse of the first clock signal and the effective pulse of the second clock signal are within the first time period, and the effective pulse of the third clock signal is within the second time period.

9. The display panel according to claim 4, wherein within the one clock cycle in the forward scan mode, a duration of the effective pulse of the third clock signal in the x^{th}-stage shift register unit is before a duration of the effective pulse of the second clock signal in the y^{th}-stage shift register unit;
within the one clock cycle in the reverse scan mode, the duration of the effective pulse of the third clock signal in the k^{th}-stage shift register unit is before the duration of the effective pulse of the second clock signal in the y^{th}-stage shift register unit.

10. The display panel according to claim 1, wherein in the forward scan mode, a duration of the effective pulse of the second gate signal output by an i^{th}-stage shift register unit is before a duration of the effective pulse of the first gate signal output by an (i+1)^{th}-stage shift register unit;
in the reverse scan mode, the duration of the effective pulse of the second gate signal output by the (i+1)^{th}-stage shift register unit is before the duration of the effective pulse of the first gate signal output by the i^{th}-stage shift register unit.

11. The display panel according to claim 1, wherein in the forward scan mode, the duration of the effective pulse of the first gate signal output by the i^{th}-stage shift register unit is before the duration of the effective pulse of the first gate signal output by the (i+1)^{th}-stage shift register unit; the duration of the effective pulse of the second gate signal output by the i^{th}-stage shift register unit overlaps with the duration of the effective pulse of the first gate signal output by the (i+1)^{th}-stage shift register unit; wherein i is a positive integer less than or equal to n;
in the reverse scan mode, the duration of the effective pulse of the first gate signal output by the (i+1)^{th}-stage shift register unit is before the duration of the effective pulse of the first gate signal output by the i^{th}-stage shift register unit; the duration of the effective pulse of the second gate signal output by the (i+1)^{th}-stage shift register unit overlaps with the duration of the effective pulse of the first gate signal output by the i^{th}-stage shift register unit.

12. The display panel according to claim 1, further comprising 2*m first clock signal lines and 2*m second clock signal lines when x=y−m and k=y+m, wherein m is a positive integer;
a display duration of one frame of the display panel comprises a plurality of clock cycles; a duration of a clock cycle among the plurality of clock cycles is greater than or equal to 2*m*H, wherein H is a clock unit duration; within one of the plurality of clock cycles, effective pulses of clock signals transmitted by the first clock signal lines are sequentially shifted; and within the one clock cycle, effective pulses of clock signals transmitted by the second clock signal lines are sequentially shifted;
2*m adjacent stages of shift register units among the n stages of cascaded shift register units constitute a shift register unit group; in a same shift register unit group, the first clock terminal of a stage of shift register unit among the 2*m adjacent stages of shift register units is electrically connected to a corresponding one of the first clock signal lines, and the third clock terminal of the stage of shift register unit is electrically connected to a corresponding one of the second clock signal lines;
the second clock terminal of an (i+m)^{th}-stage shift register unit and the first clock terminal of an i^{th}-stage shift register unit are electrically connected to a same first clock signal line among the first clock signal lines, wherein i is a positive integer less than or equal to n.

13. The display panel according to claim 12, wherein when m is greater than 1, a third clock signal of the i^{th}-stage shift register unit is same as a first clock signal of an (i+m+1)^{th}-stage shift register unit.

14. The display panel according to claim 1, further comprising 2*m first clock signal lines and 2*m second clock signal lines when x=y−m and k=y+m;
a display duration of one frame of the display panel comprises a plurality of clock cycles; a duration of a clock cycle among the plurality of clock cycles is greater than or equal to 2*m*H, wherein H is a clock unit duration; within one of the plurality of clock cycles, effective pulses of clock signals transmitted by the first clock signal lines are sequentially shifted; and within the one clock cycle, effective pulses of clock signals transmitted by the second clock signal lines are sequentially shifted;
2*m adjacent stages of shift register units among the n stages of cascaded shift register units constitute a shift register unit group; in a same shift register unit group, the first clock terminal of a stage of shift register unit among the 2*m adjacent stages of shift register units is electrically connected to a corresponding one of the first clock signal lines, and the second clock terminal of the stage of shift register unit is electrically connected to a corresponding one of the second clock signal lines;
the third clock terminal of an (i+m)^{th}-stage shift register unit and the first clock terminal of an i^{th}-stage shift register unit are electrically connected to a same first clock signal line among the first clock signal lines, wherein i is a positive integer less than or equal to n.

15. The display panel according to claim 14, wherein when m is greater than 1, a second clock signal of the i^{th}-stage shift register unit is same as a first clock signal of an (i+m−1)^{th}-stage shift register unit.

16. The display panel according to claim 1, further comprising m first start signal lines and m second start signal lines when x=y−m and k=y+m, wherein m is a positive integer;
the forward input terminal of a stage of the shift register unit among the first-stage shift register unit to an m^{th}-stage shift register unit is electrically connected to a corresponding one of the first start signal lines;
the reverse input terminal of a stage of the shift register unit among an (n−m+1)^{th}-stage shift register unit to the n^{th}-stage shift register unit is electrically connected to a corresponding one of the second start signal lines;
in the forward scan mode, the first start signal lines sequentially transmit an effective pulse of a first start signal;
in the reverse scan mode, the second start signal lines sequentially transmit an effective pulse of a second start signal.

17. The display panel according to claim 1, further comprising a display region; wherein the display region is provided with a plurality of pixel circuits arranged in an array;
a pixel circuit among the plurality of pixel circuits at least comprises a first preset module and a second preset module;
the first gate signal and the second gate signal of the same shift register unit are configured to control first preset module and the second preset module of a same pixel circuit among the plurality of pixel circuits to be turned on or turned off, respectively;
wherein the pixel circuit comprises a compensation module, a data write module, a reset module and a drive module;
the drive module comprises a drive transistor; the data write module is electrically connected to a first electrode of the drive transistor; the compensation module is electrically connected between a second electrode of the drive transistor and a gate of the drive transistor; the reset module is electrically connected to the gate of the drive transistor;
the first preset module comprises the reset module; the second preset module comprises at least one of the data write module or the compensation module.

18. The display panel according to claim 1, wherein the drive control module comprises a first node control sub-module, a second node control sub-module and a node mutual control sub-module;
the shift register unit further comprises a fourth clock terminal, a first level terminal and a second level terminal; in the same shift register unit, the first node control sub-module is electrically connected to the input node, the first clock terminal and the first node; the second node control sub-module is electrically connected to the first clock terminal, the first level terminal and the second node; the node mutual control sub-module is electrically connected to the second level terminal, the first node, the second node, the first clock terminal and the fourth clock terminal;
wherein a duration of an effective pulse of a fourth clock signal received by the fourth clock terminal does not overlap with a duration of an effective pulse of a first clock signal received by the first clock terminal.

19. The display panel according to claim 18, wherein the second clock terminal is configured to receive a second clock signal, and the third clock terminal is configured to receive a third clock signal;
the fourth clock signal is same as the second clock signal or the third clock signal.

20. The display panel according to claim 1, wherein
the shift register unit further comprises a first voltage regulation module; and in the same shift register unit, at least one of the first output module or the second output module is electrically connected to the first node through the first voltage regulation module; or
the shift register unit further comprises a second voltage regulation module and a third voltage regulation module; in the same shift register unit, the first output module is electrically connected to the first node through the second voltage regulation module; and the second output module is electrically connected to the first node through the third voltage regulation module.

21. The display panel according to claim 1, wherein at least one of the following is satisfied:
the first output module comprises a first output transistor and a second output transistor; the shift register unit further comprises a second level terminal; in the same shift register unit, a gate of the first output transistor is electrically connected to the first node, a first electrode of the first output transistor is electrically connected to the second clock terminal, and a second electrode of the first output transistor is electrically connected to the first output terminal; and a gate of the second output transistor is electrically connected to the second node, a first electrode of the second output transistor is electrically connected to the second level terminal, and a second electrode of the second output transistor is electrically connected to the first output terminal; or
the second output module comprises a third output transistor and a fourth output transistor; the shift register unit further comprises a second level terminal; in the same shift register unit, a gate of the third output transistor is electrically connected to the first node, a first electrode of the third output transistor is electrically connected to the third clock terminal, and a second electrode of the third output transistor is electrically connected to the second output terminal; and a gate of the fourth output transistor is electrically connected to the second node, a first electrode of the fourth output transistor is electrically connected to the second level terminal, and a second electrode of the fourth output transistor is electrically connected to the second output terminal.

22. A display device, comprising a display panel, wherein the display panel comprises a driver circuit, wherein the driver circuit comprises n stages of cascaded shift register units, wherein n is a positive integer greater than or equal to 2;
a shift register unit among the n stages of cascaded shift register units comprises a scan control module, a drive control module, a first output module, a second output module, a forward input terminal, a reverse input terminal, a forward control terminal, a reverse control terminal, a first clock terminal, a second clock terminal, a third clock terminal, a first output terminal and a second output terminal; in a same shift register unit among the n stages of cascaded shift register units, the scan control module is electrically connected to the forward input terminal, the reverse input terminal, the forward control terminal, the reverse control terminal and an input node, the drive control module is at least electrically connected to the input node, the first clock terminal, a first node and a second node, the first output module is at least electrically connected to the first node, the second node, the second clock terminal and the first output terminal, and the second output module is at least electrically connected to the first node, the second node, the third clock terminal and the second output terminal;
the first output terminal or the second output terminal of an x^{th}-stage shift register unit is electrically connected to the forward input terminal of a y^{th}-stage shift register unit, and the reverse input terminal of the y^{th}-stage shift register unit is electrically connected to the first output terminal or the second output terminal of a k^{th}-stage shift register unit; wherein 1≤x<y<k≤n, and x, y and k are positive integers;
in the same shift register unit, an effective pulse of a first gate signal output from the first output terminal and an effective pulse of a second gate signal output from the second output terminal are sequentially shifted;
an operating mode of the display panel comprises a forward scan mode and a reverse scan mode; in the forward scan mode, a first-stage shift register unit to an n^{th}-stage shift register unit sequentially output the effective pulse of the first gate signal and sequentially output the effective pulse of the second gate signal; in the reverse scan mode, the n^{th}-stage shift register unit to the first-stage shift register unit sequentially output the effective pulse of the first gate signal and sequentially output the effective pulse of the second gate signal.
